(19) United States
(12) Patent Application Publication
(10) Pub. No.: US 2026/0318765 A1
(43) Pub. Date: Oct. 15, 2026

(54) PRESSURE SENSING CHIP AND PRESSURE SENSOR

(71) Applicants: BEIJING BOE SENSOR TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Yue Li, Beijing (CN); Lihui Wang, Beijing (CN); Qiuxu Wei, Beijing (CN); Weilong Guo, Beijing (CN); Taonan Zhang, Beijing (CN); Wenbo Chang, Beijing (CN); Jie Sun, Beijing (CN); Nana He, Beijing (CN); Hanqing Liu, Beijing (CN); Ding Ding, Beijing (CN)

(73) Assignees: BEIJING BOE SENSOR TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(21) Appl. No.: 18/995,977

(22) PCT Filed: Dec. 22, 2023
(86) PCT No.: PCT/CN2023/140976

§ 371 Date: Jan. 17, 2025

(51) Int. Cl. G01L 9/06; G01L 9/12; G01L 19/14

(52) U.S. Cl. CPC G01L 9/06; G01L 9/12; G01L 19/14

(57) ABSTRACT

The present disclosure provides a pressure sensing chip and a pressure sensor, belonging to the field of sensor technologies and aiming at improving the service life of sensors and increasing application scenarios. The pressure sensing chip includes: a pressure-sensitive film; a substrate connected to the pressure-sensitive film, wherein a cavity is formed between the pressure-sensitive film and the substrate; a pressure-sensitive component located between the substrate and the pressure-sensitive film, wherein the pressure-sensitive component partially overlaps with an orthographic projection of the cavity on the substrate; and a first signal output structure arranged on a side of the substrate away from the pressure-sensitive film, wherein the first signal output structure is electrically connected to the pressure-sensitive component through a lead structure penetrating through the substrate.

### FIELD

The present disclosure relates to the field of sensor technologies, and more particularly to a pressure sensing chip and a pressure sensor.

### BACKGROUND

A pressure sensor is a device that can convert pressure signals into electrical signals. The pressure sensor usually consists of three parts such as a sensitive chip, a processing circuit and a package. The sensitive chip (also known as a pressure chip) is a structure that directly senses the pressure signals and is a core device of the whole sensor.

### SUMMARY

The present disclosure provides a pressure sensing chip, including:
a pressure-sensitive film;
a substrate connected to the pressure-sensitive film, wherein a cavity is formed between the pressure-sensitive film and the substrate;
a pressure-sensitive component located between the substrate and the pressure-sensitive film, wherein the pressure-sensitive component partially overlaps with an orthographic projection of the cavity on the substrate; and
a first signal output structure arranged on a side of the substrate away from the pressure-sensitive film,
wherein the first signal output structure is electrically connected to the pressure-sensitive component through a lead structure penetrating through the substrate.

For example, an orthographic projection of the pressure-sensitive component on the substrate is located within the orthographic projection of the cavity on the substrate; or an orthographic projection of the pressure-sensitive component on the substrate overlaps with the orthographic projection of the cavity on the substrate.

For example, the pressure-sensitive component is located on a side of the pressure-sensitive film close to the substrate, or the pressure-sensitive component is distributed on opposite sides of the cavity in a target direction, wherein the target direction is a vertical direction that the substrate towards the pressure-sensitive film.

For example, the pressure-sensitive component includes a first electrode and a second electrode arranged at intervals, and the first electrode and the second electrode are both arranged on a side of the pressure-sensitive film close to the cavity,
wherein the first electrode and the second electrode are configured to convert a deformation of the pressure-sensitive film into a resistance signal.

For example, the pressure-sensitive component includes a third electrode and a fourth electrode, and the third electrode and the fourth electrode are configured to convert a deformation of the pressure-sensitive film into a capacitance signal,
wherein the third electrode is arranged on the side of the pressure-sensitive film close to the cavity, the fourth electrode is arranged on a side of the substrate close to the cavity, and an orthographic projection of the third electrode on the substrate overlaps with the fourth electrode.

For example, the pressure-sensitive film includes a thinned region and a non-thinned region, and a thickness of the thinned region is less than a thickness of the non-thinned region,
wherein an orthographic projection of the thinned region on the substrate overlaps with the orthographic projection of the cavity on the substrate.

For example, the orthographic projection of the thinned region on the substrate is covered by the orthographic projection of the cavity on the substrate, and an orthographic projection of the non-thinned region on the substrate overlaps with the orthographic projection of the cavity on the substrate.

For example, the lead structure includes a first lead post and an extraction electrode, one end of the extraction electrode is connected to the pressure-sensitive component, the other end of the extraction electrode is connected to one end of the first lead post, and the other end of the first lead post penetrates through the substrate and is electrically connected to the first signal output structure.

For example, the extraction electrode is arranged in a same layer as the pressure-sensitive component.

For example, an orthographic projection of the extraction electrode on the substrate does not overlap with the orthographic projection of the cavity on the substrate.

For example, an insulating layer is further arranged on a side of the pressure-sensitive film close to the substrate, wherein the pressure-sensitive component is located on a side of the insulating layer away from the pressure-sensitive film.

For example, the pressure sensing chip further includes: a spacer and a sealing ring located on at least one side of the spacer,
wherein the pressure-sensitive film is hermetically connected to the substrate through the sealing ring and the spacer.

For example, the first signal output structure includes a signal access terminal and a signal output terminal,
wherein the signal access terminal is respectively connected to the first lead post and the signal output terminal, and the signal output terminal is configured to transmit electrical signals input by the signal access terminal to an external signal processing circuit.

For example, the signal access terminal includes:
a metal binding region arranged on a side of the substrate away from the cavity and electrically connected to the first lead post; and
a metal transition region arranged on the side of the substrate away from the pressure-sensitive film and respectively connected to the metal binding region and the signal output terminal.

For example, the signal output terminal includes any one of a metal wire, a solder joint and a first bonding bump,
wherein the first bonding bump and the metal transition region are integrally formed for bonding with a second bonding bump on the external signal processing circuit.

A pressure sensor, including the pressure sensing chip and a packaging structure, wherein the packaging structure includes:
a signal processing circuit;
a packaging part, wherein the pressure sensing chip is mounted on the packaging part, the packaging part is provided with a closed cavity, and at least the signal processing circuit exists in the closed cavity; and
a second signal output structure configured to the packaging part,
wherein the first signal output structure of the pressure sensing chip is electrically connected to an input terminal of the signal processing circuit, an output terminal of the signal processing circuit is electrically connected to the second signal output structure, and the second signal output structure is configured to outwardly output electrical signals processed by the signal processing circuit.

For example, the pressure sensing chip as a whole is located outside the closed cavity, and the first signal output structure is connected to the packaging part; or
the pressure sensing chip as a whole is located in the closed cavity, wherein the pressure-sensitive film is hermetically connected to the packaging part, the packaging part is provided with a through hole allowing media to be measured to flow in, and the through hole is connected to the pressure-sensitive film.

For example, the packaging part includes:
a mounting part, wherein the pressure sensing chip and the signal processing circuit are mounted on a same side or opposite sides of the mounting part;
a supporting part connected to the mounting part for supporting the mounting part; and
a sealed housing is hermetically connected to the supporting part to form the closed cavity with the supporting part; or the sealed housing is hermetically connected to the mounting part to form the closed cavity with the supporting part,
wherein the second signal output structure is connected to the sealed housing.

For example, the pressure sensing chip and the signal processing circuit are located on a same side of the mounting part, and the pressure-sensitive film of the pressure sensing chip is bonded to the mounting part,
wherein the mounting part and the supporting part are each provided with a first through hole allowing media to be measured to flow in, and a side of the pressure-sensitive film away from the cavity is connected to the first through hole.

For example, a radius of the first through hole in the mounting part is less than a radius of the first through hole in the supporting part.

For example, the pressure sensing chip and the signal processing circuit are located on opposite sides of the mounting part, there is a gap between the pressure sensing chip and the supporting part, and the first signal output structure is bonded to the mounting part; and
a third lead post penetrates through the mounting part, one end of the third lead post is connected to the first signal output structure, and the other end is connected to the signal processing circuit.

For example, the mounting part includes: a signal adapter plate and an insulating base arranged opposite to each other,
wherein the signal adapter plate is located in the closed cavity, and the signal processing circuit is located on a side of the signal adapter plate away from the supporting part;
wherein the signal adapter plate is further provided with a thick film circuit, the thick film circuit is arranged on a same side as the signal processing circuit and is electrically connected to the signal processing circuit; and
wherein the first signal output structure is packaged on a side of the insulating base away from the signal adapter plate, an end of the third lead post is electrically connected to the first signal output structure, and the other end of the third lead post is electrically connected to the signal processing circuit after penetrating through the insulating base and the signal adapter plate in turn.

For example, the supporting part is provided with a second through hole penetrating therethrough, wherein one end of the second through hole is used to flow the media to be measured, and the other end of the second through hole is connected to a side of the pressure-sensitive film away from the cavity.

For example, the insulating base and the pressure sensing chip are located at a liquid outlet of the second through hole, and the second through hole is arranged on the supporting part; or
the insulating base and the pressure sensing chip are located at a liquid inlet of the second through hole, the insulating base is hermetically connected to the second through hole, and two third lead posts penetrate through the signal adapter plate after penetrating through the insulating base and extending in the second through hole.

For example, the first signal output structure is welded to a side of the mounting part through a solder joint,
wherein the mounting part further includes a protective layer arranged on a same side as the pressure sensing chip, the protective layer completely covers the solder joint, and a thickness of the protective layer is less than a thickness of the pressure sensing chip.

For example, the first signal output structure includes a plurality of first bonding bumps, and the mounting part further includes a plurality of slurry bonding layers and a plurality of second bonding bumps spaced apart from each other, wherein the plurality of slurry bonding layers are located outside the plurality of first bonding bumps; and
wherein the plurality of second bonding bumps are bonded to the plurality of first bonding bumps, and the plurality of slurry bonding layers are hermetically bonded to a substrate of the pressure sensing chip.

The pressure sensing chip in the present disclosure includes a pressure-sensitive film and a substrate hermetically connected to the pressure-sensitive film, and the substrate and the pressure-sensitive film are enclosed to form a cavity, where a pressure-sensitive component is arranged between the substrate and the pressure-sensitive film, and the pressure-sensitive component partially overlaps with an orthographic projection of the cavity on the substrate; a first signal output structure is arranged on a side of the substrate, and the first signal output structure is electrically connected to the pressure-sensitive component through a lead structure penetrating through the substrate. In the pressure sensing chip proposed by the present disclosure, since the pressure-sensitive component is the structure that plays main electrical functions in the pressure sensing chip, the electrode structure with the main electrical functions is protected between the substrate and the pressure-sensitive film, so that the pressure-sensitive component will not be affected by an external environment, and thus the pressure of the corrosive media to be measured can be directly measured.

The above description is only an overview of technical solutions of the present disclosure. In order to understand technical means of the present disclosure more clearly, it can be implemented according to contents of the specification, and in order to make the above and other purposes, features and advantages of the present disclosure more obvious and understandable, the specific embodiments of the present disclosure are provided below.

### BRIEF DESCRIPTION OF THE DRAWINGS

In order to more clearly illustrate the technical solutions in the embodiments of the present disclosure or the related art, accompanying drawings needed in the description of the embodiments or the related art will be briefly introduced below. It is obvious that the accompanying drawings in the following description are some embodiments of the present disclosure. For a person skilled in the art, other drawings can be obtained according to these drawings without creative labor. It should be noted that proportions in the accompanying drawings are only for illustration and do not represent actual proportions.

FIG. 1 illustrates a schematic cross-sectional structure of a pressure sensing chip in an embodiment of the present disclosure.

FIG. 2 illustrates a schematic cross-sectional structure of another pressure sensing chip in an embodiment of the present disclosure.

FIG. 3a illustrates a schematic cross-sectional structure of an extraction structure in a first signal output structure.

FIG. 3b illustrates a schematic cross-sectional structure of an extraction structure in another first signal output structure.

FIG. 3c illustrates a schematic cross-sectional structure of an extraction structure in yet another first signal output structure.

FIG. 4 illustrates a schematic cross-sectional structure of another pressure sensing chip.

FIG. 5a to FIG. 5c respectively illustrate schematic cross-sectional structures of three pressure sensing chips.

FIG. 6a illustrates a schematic cross-sectional structure of a piezoresistive pressure sensing chip.

FIG. 6b illustrates a schematic cross-sectional structure of a capacitive pressure sensing chip.

FIG. 6c illustrates a schematic cross-sectional structure of another capacitive pressure sensing chip.

FIG. 6d illustrates a schematic cross-sectional structure of a pressure sensing chip in an example Al.

FIG. 6e illustrates a schematic cross-sectional structure of a pressure sensing chip in an example A2.

FIG. 7a and FIG. 7b respectively illustrate schematic cross-sectional structures of two pressure sensors in an embodiment of the present disclosure.

FIG. 8a and FIG. 8b respectively illustrate schematic cross-sectional structures of two pressure sensors.

FIG. 9 illustrates a schematic structural diagram of a supporting part in an embodiment of the present disclosure.

FIG. 10 illustrates a schematic structural diagram of a second signal output structure in an embodiment of the present disclosure.

FIG. 11a illustrates a schematic diagram of a packaging structure of a pressure sensing chip in an embodiment of the present disclosure.

FIG. 11b illustrates a schematic diagram of a packaging structure of another pressure sensing chip in an embodiment of the present disclosure.

FIG. 11c illustrates a schematic diagram of a packaging structure of a mounting part and a pressure sensing chip in an embodiment of the present disclosure.

FIG. 11d and FIG. 11e respectively illustrate schematic diagrams of packaging structures of two pressure sensors.

FIG. 12a illustrates a schematic enlarged partial diagram in a circular dashed box in FIG. 11c.

FIG. 12b illustrates a schematic change structure diagram in a circular dashed box in FIG. 12a.

FIG. 13a illustrates a schematic cross-sectional structure of a pressure sensor in an example B1.

FIG. 13b illustrates a schematic cross-sectional structure of a pressure sensor in an example B2.

FIG. 13c illustrates a schematic cross-sectional structure of a pressure sensor in an example B3.

FIG. 14 illustrates a schematic diagram of a packaging process of a pressure sensor.

### DESCRIPTION OF REFERENCE SIGNS

10. Pressure sensing chip; 1. Pressure-sensitive film; 2. Substrate; 3. Cavity; 4. Pressure-sensitive component; 52. First signal output structure; 51. Lead structure; 511. First lead post; 512. Extraction electrode; 521. Metal binding region; 522. Metal transition region; 523. Signal output terminal; 231. Metal wire; 232. Solder joint; 233. First bonding bump; 11. Thinned region; 12. Non-thinned region; 6. Insulating layer; 41. First electrode; 42. Second electrode; 43. Third electrode; 44. Fourth electrode; 7. Spacer; 8. Sealing ring; 20. Packaging part; 30. Closed cavity; 40. Signal processing circuit; 401. ASIC chip; 402. Resistance-capacitance component; 101. Target region; 50. Second signal output structure; 9. AF wire; 201. Mounting part; 202. Supporting part; 203. Sealed housing; 2011. Third lead post; 2012. Signal adapter plate; 2013. Insulating base; 221. Boss of first mounting table; 222. Boss of second mounting table; 223. Second through hole; 501. Connector; 502. Insulator; 503. Second lead post; 224. First through hole; 31. First region; 32. Second region; 131. Protective layer; 132. Second bonding bump; 133. Slurry bonding layer; 111. Insulating part; 112. Metal part.

### DETAILED DESCRIPTION

In order to make the objects, the technical solutions and the advantages of the embodiments of the present disclosure clearer, the technical solutions of the embodiments of the present disclosure may be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

According to the principle of pressure chips, pressure sensors can be classified into four main types such as piezoresistive, capacitive, resonant and piezoelectric. In the related art, the pressure chips are of a positive pressure-sensing type and cannot be directly used for pressure measurement of liquid pressure media. If pressure media in complex environments, for example, corrosive gases or liquid pressure media, the pressure chips need to be oil-filled for secondary packaging to protect main electrical structures of the pressure chips. However, the secondary packaging of the pressure chips increases the volume and the cost of the chips.

In view of this, the present disclosure proposes a pressure chip that can directly measure the pressure of corrosive media, which can directly measure the pressure of liquids and corrosive gases. Specifically, the proposed pressure sensing chip can protect the electrode structure with the main electrical functions between the pressure-sensitive film and the substrate, and be covered by the pressure-sensitive film and the substrate, so as to prevent the electrode structure from contacting with an external environment, thereby enabling the pressure sensing chip to carry out back pressure sensing. In this way, even if the pressure sensing chip is in direct contact with liquids, the performance of the electrode structure with the main electrical functions will not be affected, and there will be no electrical performance drift or failure, and thus the pressure sensing chip can be directly used for measuring the pressure of corrosive media.

Hereinafter, the pressure sensing chip proposed by the present disclosure will be will be introduced and explained in conjunction with the accompanying drawings.

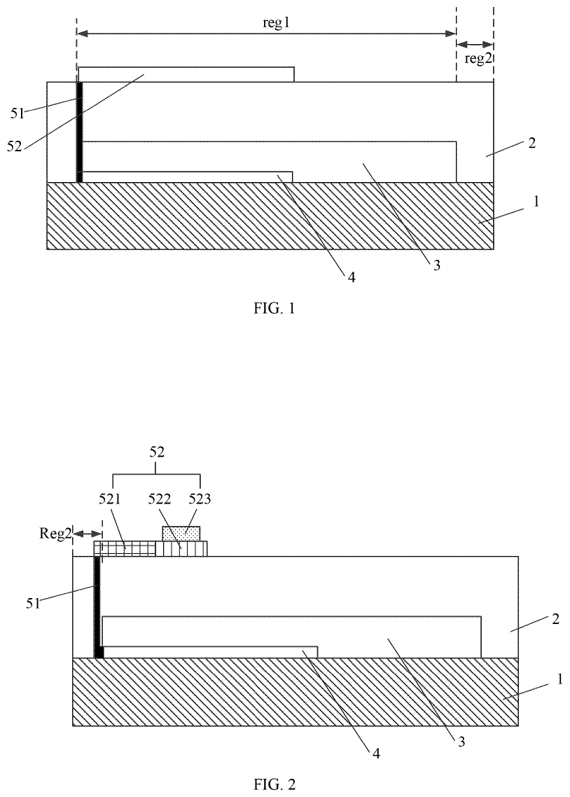

Referring to FIG. 1, FIG. 1 illustrates a schematic cross-sectional structure of a pressure sensing chip. As shown in FIG. 1, a pressure sensing chip 10 in an embodiment of the present disclosure can include a pressure-sensitive film 1, a substrate 2, a pressure-sensitive component 4 and a first signal output structure 52.

The substrate is hermetically connected to the pressure-sensitive film, and the substrate and the pressure-sensitive film are enclosed to form a cavity 3. The pressure-sensitive film is configured to deform with a pressure change of the external environment, and the cavity is configured to provide an environment in which the pressure-sensitive film is deformed under the pressure.

The pressure-sensitive component is located between the substrate and the pressure-sensitive film, and the pressure-sensitive component partially overlaps with an orthographic projection of the cavity on the substrate. The pressure-sensitive component is configured to convert deformation signals of the pressure-sensitive film into electrical signals.

The substrate is configured with a first signal output structure, which is electrically connected to the pressure-sensitive component and configured to output the electrical signals generated by the pressure-sensitive component.

Specifically, the first signal output structure can be electrically connected to the pressure-sensitive component 4 through a lead structure 51 penetrating through the substrate.

In this embodiment, a sealing method of the pressure-sensitive film and the substrate can include snap sealing, bonding sealing or welding sealing. After the pressure-sensitive film and the substrate are hermetically connected, a sealed cavity is formed between the pressure-sensitive film and the substrate, and at least one side of cavity walls of the cavity can be a side of the pressure-sensitive film; or a side of the pressure-sensitive film close to the cavity and a side of the substrate close to the cavity are both used as the cavity walls of the cavity. The pressure-sensitive film can deform with the pressure change of the external environment, and in another example, the substrate can also deform with the pressure change of the external environment; therefore, both the pressure-sensitive film and the substrate can deform with the pressure change of the external environment, and in practice, any design method can be selected. Of course, the substrate can also be a rigid substrate, which does not deform with the pressure change of the external environment.

The cavity can provide the environment for the pressure-sensitive film to deform. Specifically, the cavity can be a vacuum cavity or a cavity containing a small amount of air. A size and a shape of the cavity can be set flexibly. For example, a cross-sectional shape of the cavity can be trapezoidal, so that the cavity can provide a more flexible deformation environment for the pressure-sensitive film to deform; or the cross-sectional shape of the cavity can also be rectangular, semi-circular, and the like, which will not be repeated here.

The size of the cavity can be determined according to an overall size of the pressure sensing chip. For example, the size of the cavity in a stacking direction of the pressure-sensitive film and the substrate can be 0.5 mm-1 mm, and the size of the cavity in an extending direction of the pressure-sensitive film can be greater than the size of the cavity in the stacking direction of the pressure-sensitive film and the substrate, for example, the size can be 1 mm-2 mm.

Materials of the pressure-sensitive film and the substrate can be made of insulating materials such as silicon, glass fiber, polyethylene, polypropylene, and the like. The materials of the pressure-sensitive film and the substrate can be the same or different. More specifically, the pressure-sensitive film or the substrate can be made of deformable insulating materials, or both the pressure-sensitive film and the substrate can be made of deformable insulating materials. In the case where the pressure-sensitive film and the substrate are both made of deformable materials, a thickness of the pressure-sensitive film is less than a thickness of the substrate, so that the pressure-sensitive film can more sensitively sense changes in external pressure.

Under the pressure of media to be measured in the external environment, the pressure causes the pressure-sensitive film to deform with the support of the cavity. More specifically, at least the thickness of the pressure-sensitive film at a position of the cavity needs to be relatively small, that is, a thickness of a region covered by an orthographic projection of the cavity on the pressure-sensitive film is relatively small, in order to more sensitively sense pressure signals at the cavity and improve the sensitivity of the pressure-sensitive film to deform with the pressure. Here, the relatively small thickness can mean that a thinning process is performed on the pressure-sensitive film at the position of the cavity, while a thickness at a position other than the cavity can be relatively large.

Specifically, the thinning process can also be performed on the substrate at the position of the cavity, while a thickness at a position other than the cavity can be relatively large. For example, as shown in FIG. 1, a thickness of a region reg1 at the position of the cavity on the substrate is relatively small, while a thickness of a region reg2 at the position other than the cavity is relatively large.

In order to form the cavity between the pressure-sensitive film and the substrate after the pressure-sensitive film is hermetically connected to the substrate, a groove can be formed on one side of the pressure-sensitive film or the substrate. When connecting the pressure-sensitive film and the substrate, the side with the groove can be hermetically connected to another structure (the substrate or the pressure-sensitive film), and then re-evacuated, so that a position of the groove is the position of the cavity. As shown in FIG. 1, grooves can be provided on the substrate. Of course, in other examples, grooves can also be provided on the pressure-sensitive film.

The pressure-sensitive component can include a plurality of electrodes, or one or more deformation elements and one or more signal generating elements connected to the deformation elements.

The pressure-sensitive component is located between the pressure-sensitive film and the substrate, and specifically, the pressure-sensitive component can be covered by the pressure-sensitive film and the substrate. An arrangement method that the pressure-sensitive component partially overlaps with the orthographic projection of the cavity on the substrate can be that a part of the structure of the pressure-sensitive component is located at the junction between the pressure-sensitive film and the substrate, and the rest of the structure is located in the cavity; or the pressure-sensitive component are all located in the cavity. Specific settings can be made according to actual needs without any special restrictions here.

For example, if the pressure-sensitive component includes one or more electrodes and one or more deformation elements, the electrodes and the deformation elements can be a thin film metal layer formed on the pressure-sensitive film, which can be insulated from the cavity walls of the cavity. For another example, if the pressure-sensitive component includes a plurality of electrodes, the plurality of electrodes can be distributed on the same side of the cavity or on different sides of the cavity, which can be determined according to the type of the pressure sensing chip. Of course, in some examples, there may be spaces between the plurality of electrodes, for example, capacitive and resistive pressure sensing chips. For another example, if the pressure-sensitive component includes one or more deformation elements and one or more signal generating elements, the deformation elements can be connected to the signal generating elements, and the deformation elements deform with the deformation of the pressure-sensitive film and transmit deformation signals to the signal generating elements, so that the signal generating elements can generate corresponding electrical signals based on the deformation signals, for example, a resonant pressure sensing chip.

The electrodes and the deformation elements in the pressure-sensitive component can be made of metal materials, and the pressure-sensitive component can be varistors or ordinary electrodes. When the pressure-sensitive component is the varistors, the resistivity changes with the deformation of the pressure-sensitive film; and when the pressure-sensitive component is the ordinary electrodes, it can be configured to change the capacitance and the resonance frequency when the cavity deforms. Specifically, a plurality of electrodes can generate corresponding electrical signals in response to the deformation of the pressure-sensitive film, for example, resistance signals, capacitance signals, resonance signals, and the like, so that the pressure of the media to be measured can be determined according to the electrical signals generated by the plurality of electrodes in the pressure-sensitive component.

The substrate can be configured with a first signal output structure, which is connected to the electrodes in the pressure-sensitive component to receive the electrical signals generated by the electrodes and transmits the electrical signals to an external signal processing circuit. In some examples, as shown in FIG. 1, the first signal output structure can be electrically connected to the pressure-sensitive component through a lead structure connected to the pressure-sensitive component. The lead structure can be embedded in the substrate and sealed with the substrate, one end of the lead structure is connected to the pressure-sensitive component, and the other end of the lead structure is connected to the first signal output structure. Specifically, the lead structure can be one or more metal wires penetrating in the substrate, and after extending on the cavity walls of the cavity, the metal wires are connected to the electrodes in the pressure-sensitive component. The first signal output structure can be located on an outer side of the substrate away from the cavity, thereby realizing the electrical connection between the pressure-sensitive component in the cavity and the external signal processing circuit.

In some embodiments, the process of forming the pressure sensing chip can be as follows: configuring a first signal output structure on a substrate; forming a groove on the substrate; and forming a pressure-sensitive component on one side of a pressure-sensitive film; then, bonding the side of the pressure-sensitive film provided with the pressure-sensitive component to a side of the substrate provided with the groove using an anodic bonding process; and evacuating the groove to form a cavity after bonding, so that the pressure-sensitive component is located between the substrate and the pressure-sensitive film and is covered by the substrate and the pressure-sensitive film. In this way, as the key structure of the pressure sensing chip, the pressure-sensitive component can be protected between the substrate and the pressure-sensitive film to avoid being affected by the external environment.

When performing pressure measurement, the pressure-sensitive film will deform due to the influence of external pressure, which will cause the pressure-sensitive component to generate corresponding electrical signals such as resistance change signals or capacitance change signals; the generated electrical signals will be transmitted to the first signal output structure through the lead structure and outwardly output through the first signal output structure. Therefore, the pressure sensing chip can be understood as a back pressure sensing pressure detection.

Using the pressure sensing chip of this embodiment, the pressure-sensitive component can be protected between the substrate and the pressure-sensitive film, so that the structure that plays the main electrical functions in the pressure sensing chip will not be directly exposed to the outside, thereby preventing the pressure-sensitive component from being affected by the external environment. In this way, even if the pressure sensing chip directly contacts corrosive media such as liquids, the pressure-sensitive component will not drift or fail, thereby enabling the pressure sensing chip to maintain a long-term pressure detection capability.

In some exemplary embodiments, both the pressure-sensitive film and the substrate can be flexible substrates, that is, both the pressure-sensitive film and the substrate can deform to some extent, and in such instances, the thickness of the pressure-sensitive film is less than the thickness of the substrate. The materials of the pressure-sensitive film and the substrate can be the same or different, for example, the pressure-sensitive film and the substrate can both be made of silicon materials, or the pressure-sensitive film is made of silicon materials and the substrate is made of polymer materials such as polyurethane, polypropylene, polyimide, and the like. Since the substrate is made of flexible materials, when it is used as a carrier of the first signal output structure, it can provide a deformation space for the deformation of the first signal output structure, for example, tension and compression, and reduce the probability of problems such as fracture and damage caused by the deformation of the first signal output structure due to force majeure.

In some exemplary embodiments, the pressure-sensitive film is made of flexible materials, and the substrate may be a rigid substrate. In such instances, the substrate can provide a stronger supporting force for the pressure sensing chip and provide a carrier for the first signal output structure, and the pressure-sensitive film can sense the pressure change. In such instances, the substrate can be a glass substrate, which can reduce the process difficulty for punching the metal wires of the first signal output structure. In the case where the substrate is the rigid substrate, the substrate can provide stable electrical bearing for the first signal output structure without deformation. In such instances, the pressure-sensitive film providing deformation and the substrate providing bearing for the first signal output structure can be distinguished, that is, two functions of deforming the pressure sensing chip and providing the carrier are assigned to different substrates, and thus the design difficulty of the pressure sensing chip can be reduced and the manufacturing efficiency can be improved.

In the exemplary embodiments, the material of the pressure-sensitive film can be silicon, and the material of the rigid substrate can be glass. In this case, when the substrate made of glass is hermetically connected to the pressure-sensitive film made of silicon, the bonding difficulty between the substrate and the pressure-sensitive film can be reduced. In other examples, the material of the pressure-sensitive film can also be a flexible polymer material, and the material of the rigid substrate can also be quartz or ceramic.

In some exemplary embodiments, the first signal output structure can be arranged on the substrate, and can include a signal access terminal and a signal output terminal.

The signal access terminal is respectively connected to the lead structure and the signal output terminal, and the signal output terminal is configured to transmit electrical signals input by the signal access terminal to an external signal processing circuit.

The signal access terminal and the signal output terminal can be located on the same side of the substrate, or on adjacent sides of the substrate, which will not be repeated here.

In a further example, the signal access terminal can include a metal binding region and a metal transition region. The metal binding region is arranged on one side of the substrate away from the cavity and is electrically connected to a first lead post; and the metal transition region is arranged on the side of the substrate away from the pressure-sensitive film and is respectively connected to the metal binding region and the signal output terminal. Referring to FIG. 2, FIG. 2 illustrates a schematic cross-sectional structure of another pressure sensing chip. As shown in FIG. 2, the first signal output structure in the pressure sensing chip includes a metal binding region, a metal transition region and a signal output terminal.

Specifically, the metal binding region 521 is arranged on one side of the substrate away from the cavity and is connected to one end of the lead structure away from the cavity.

The metal transition region 522 is arranged on the side of the substrate away from the cavity and is connected to the metal binding region and the signal output terminal 523.

The metal binding region can be located on the side of the substrate away from the cavity, for example, the metal binding region can be located on a side of the substrate away from the pressure-sensitive film; or the metal binding region can be located on a side of the substrate away from the cavity and adjacent to the pressure-sensitive film, for example, an outer side wall of the substrate in FIG. 2. The metal binding region can be electrically connected to one end of the lead structure away from the cavity and to the metal transition region, and the electrical connection method with the lead structure can be welding, bonding with conductive adhesive, and the like. The metal binding region can be a copper re-distributed layer (RDL) in the wafer-level package, and can transmit electrical signals on the lead structure to the metal transition region.

The metal transition region is also located on one side of the substrate away from the cavity, and can be arranged in the same layer as the metal binding region or in different layers from the metal binding region on the side of the substrate. In the case of the same layer, the metal transition region can be located on the same side of the substrate together with the metal binding region, for example, both the metal transition region and the metal binding region are located on the side of the substrate away from the pressure-sensitive film, or both the metal transition region and the metal binding region are located on the side of the substrate away from the cavity and adjacent to the pressure-sensitive film. Since the first signal output structure needs to be electrically connected to the external signal processing circuit, in this case, the bonding difficulty with the signal processing circuit can be reduced.

In the case of different layers, the metal transition region can be located on the side of the substrate away from the pressure-sensitive film, and the metal binding region can be located on the side of the substrate away from the cavity and adjacent to the pressure-sensitive film; or the metal binding region can be located on the side of the substrate away from the pressure-sensitive film, and the metal transition region can be located on the side of the substrate away from the cavity and adjacent to the pressure-sensitive film; or the metal binding region and the metal transition region can be located on the same side of the substrate, but the metal binding region and the metal transition region can be stacked, where the metal transition region can be located on a side of the metal binding region away from the substrate. In practice, any setting method can be selected, which will not be repeated here.

One end of the metal transition region is electrically connected to the metal binding region, and the other end of the metal transition region can be electrically connected to the signal output terminal 523 to transmit the electrical signals of the metal binding region to the signal output terminal. In practice, the metal transition region can be understood as a bonding layer for electrically connecting the metal binding region and the signal output terminal. In some specific implementations, the metal transition region can be composed of multilayer metal films such as adhesion layers, diffusion barrier layers and wetting layers, and can play the role of adhesion to the metal binding region and the signal output terminal, and diffusion barrier.

The signal output terminal is made of metal materials and electrically connected to the metal transition region. The connection method can be welding, bonding, conductive adhesive bonding, and the like. In specific implementations, the signal output terminal can be a metal solder joint, a metal lead or a metal bonding point.

Using the first signal output structure in this example, if the pressure-sensitive component includes a plurality of electrodes, each of the plurality of electrodes corresponds to a set of first signal output structures described above, that is, each electrode can be electrically connected to an external signal processing circuit through a lead structure, a metal binding region, a metal transition region and a signal output terminal. Due to the sealed connection between the lead structure and the substrate, the airtightness of the cavity can be ensured. The metal binding region can use the copper re-distributed layer in the wafer-level package, and thus the design cost can be reduced and more pins can be supported. In addition, the contact spacing between the metal binding region and the lead structure is more flexible and a bump area is larger, thereby reducing the stress between the substrate and other elements such as the metal transition region and improving the reliability of the pressure sensing chip. The metal transition region can use the copper re-distributed layer in the wafer-level package, and thus the design cost can be reduced and more pins can be supported. In addition, the contact spacing between the metal binding region and the lead structure is more flexible and a bump area is larger, thereby reducing the stress between the substrate and other elements such as the metal transition region and improving the reliability of the pressure sensing chip.

Further, the signal output terminal can be a metal solder joint and a metal wire, or a metal bonding point. The signal output terminal can include any one of a metal wire 231, a solder joint 232 and a first bonding bump 233. Of course, if the pressure sensing chip includes a plurality of electrodes, and each of the plurality of electrodes corresponds to a first signal output structure, a plurality of signal output terminals in a plurality of first signal output structures can be at least one of metal wires, solder joints and first bonding bumps. That is, the signal output terminals in the plurality of first signal output structures can be of the same type or different types. In the case where the signal output terminals are of the same type, the packaging difficulty will be reduced when the plurality of first signal output structures are electrically connected to the signal processing circuit of the packaging structure. Of course, it is not excluded that in some cases, the plurality of first signal output structures may have different types of signal output terminals (metal wires, solder joints and first bonding bumps).

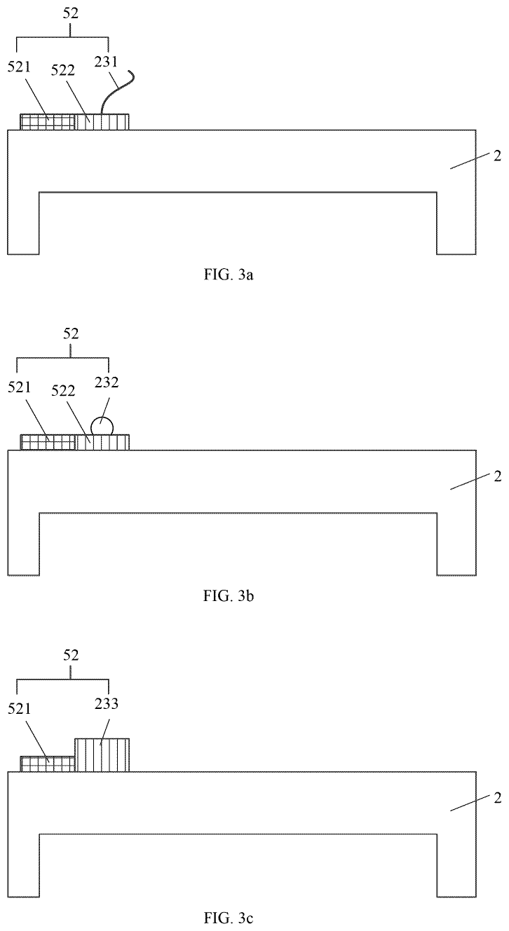

In an example of the exemplary embodiments, the signal output terminal can be a metal wire. One end of the metal wire is connected to the metal transition region, and the other end of the metal wire is used for electrical connection to the signal processing circuit. Referring to FIG. 3a, FIG. 3a illustrates a schematic cross-sectional structure of an extraction structure in a first signal output structure. As shown in FIG. 3a, the signal output terminal is a metal wire, one end of the metal wire is electrically connected to the metal transition region, for example, welding or coupling, and the other end of the metal wire is a free end used for electrical connection to the signal processing circuit. The material of the metal wire can be materials such as copper, silver, gold or aluminum. When using the metal wire, the metal wire can be directly welded to the signal processing circuit or connected to the signal processing circuit using a connector, thereby reducing the connection difficulty.

In an example of the exemplary embodiments, the signal output terminal includes a solder joint. The solder joint is located on the metal transition region and is used for soldering into the signal processing circuit to realize the electrical connection with the signal processing circuit. Referring to FIG. 3b, FIG. 3b illustrates a schematic cross-sectional structure of an extraction structure in a first signal output structure. As shown in FIG. 3b, a solder joint is arranged on a side of the metal transition region away from the substrate. The solder joint is electrically connected to the metal transition region, and the electrical connection method can be welding or bonding with conductive adhesive. The material of the solder joint can be one of tin, silver and aluminum. Of course, when using tin material, due to melting point of the tin material, it is easy to melt and adhere to a position that needs to be welded after heating. At the same time, the tin material can also play an anti-corrosion role to protect the welded signal processing circuit and metal transition region. When using the solder joint, the metal transition region can be composed of multilayer metal films such as adhesion layers, diffusion barrier layers and wetting layers.

In some specific implementations, the solder joint can be a spherical solder joint, a strip solder joint, a filiform solder joint, and the like. Of course, in order to improve the welding quality, the solder joint can be the spherical solder joint.

It should be noted that the solder joint is located on the metal transition region, and an orthographic projection of the solder joint on the substrate can be located within an orthographic projection of the metal transition region on the substrate, that is, the solder joint will not completely cover the metal transition region. In practice, a size of the solder joint in a thickness direction of the substrate should not be too large.

Further, in another example of the exemplary embodiments, the signal output terminal includes a first bonding bump. The first bonding bump is integrally formed with the metal transition region and is used for bonding with a second bonding bump on the signal processing circuit to realize electrical connection with the signal processing circuit. Referring to FIG. 3c, FIG. 3c illustrates a schematic cross-sectional structure of an extraction structure in a first signal output structure. As shown in FIG. 3c, the first bonding bump is electrically connected to the metal binding region. In this case, the first bonding bump can play the role of the metal transition region and be electrically connected to the signal processing circuit. As shown in FIG. 3c, a size of the first bonding bump in a normal direction of a plane of the substrate can be greater than a size of the metal binding region in the normal direction of the plane of the substrate. That is, a thickness of the first bonding bump is greater than a thickness of the metal binding region, so that when bonding, the first bonding bump is used as an overlapping point between the first signal output structure and the signal processing circuit, and the signal processing circuit will not overlap with the metal binding region, thereby avoiding the problem that the detection accuracy is reduced due to the increase of resistance in the circuit. The electrical connection between the first bonding bump and the metal binding region can include methods such as welding, bonding, overlapping, coupling, and the like. In this case, the first bonding bump can bond with the external packaging structure, and the first signal output structure can be connected to the signal processing circuit using the bonding method without generating high heat, polluting the environment, or consuming energy. The material of the first bonding bump can be a metal material. Specifically, the material can be copper, silver, aluminum, tin, and the like. Of course, other materials can also be suitable for the first bonding bump.

When using this signal output terminal, the metal transition region can be formed as the first bonding bump at one time, thereby simplifying the manufacturing process and improving the manufacturing efficiency.

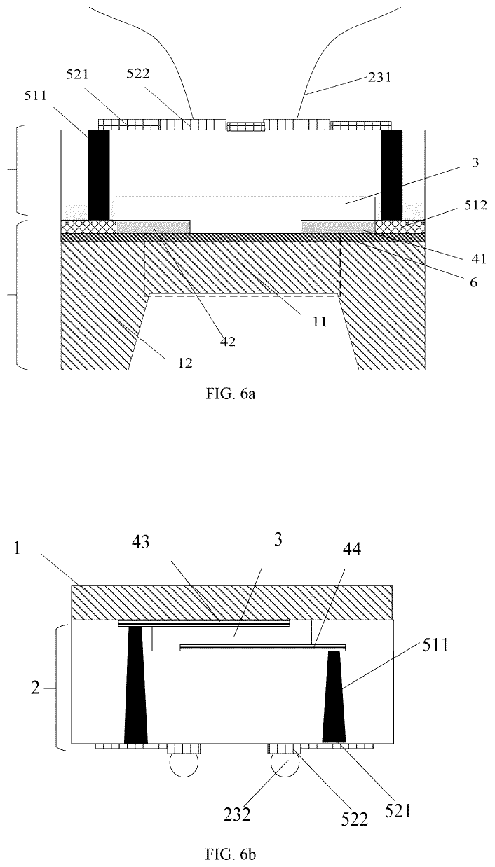

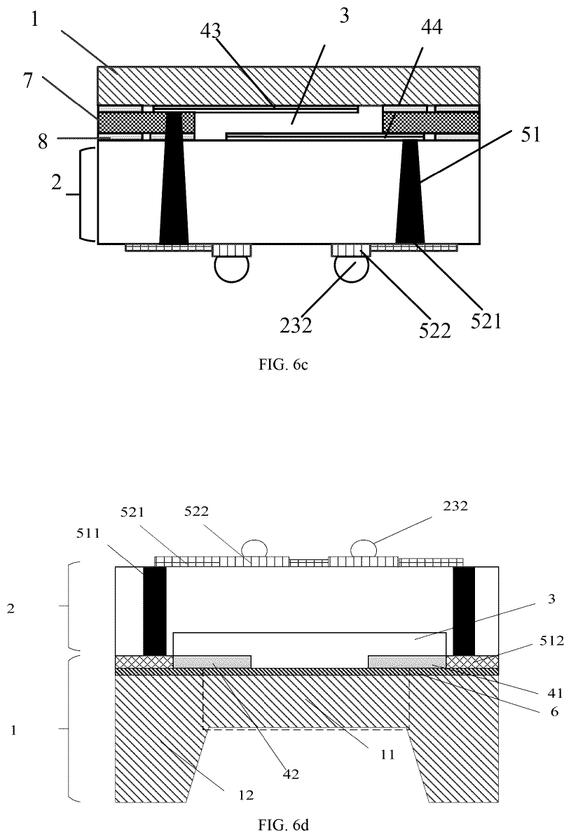

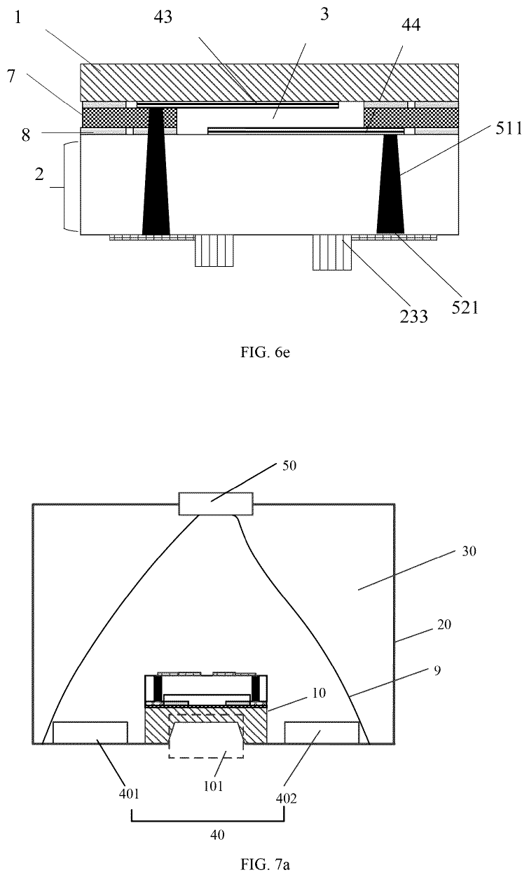

In some examples, the lead structure can only include one or more first lead posts 511 embedded in the substrate, as shown in FIG. 1, FIG. 2 and the subsequent FIG. 6b. The first lead post may not be exposed in the cavity, that is, the first lead post 511 does not need to extend into the cavity, but is connected to the pressure-sensitive component at the position where the pressure-sensitive film and the substrate are combined, so that the whole segment of the lead structure is not exposed in the cavity. In this case, the pressure-sensitive component can also have a metal region beyond the cavity, that is, the pressure-sensitive component has a partial region extending from the cavity to the substrate (see the subsequent FIG. 6b), and the first lead post is electrically connected to the pressure-sensitive component through the metal region of the pressure-sensitive component beyond the cavity. Of course, if this method is used, a size of the metal region of the pressure-sensitive component beyond the cavity can be small enough. For example, the size of the metal region can range from 0.005 mm to 0.1 mm in a length extension direction of the cavity.

In some embodiments, the lead structure can include a first lead post 511 and an extraction electrode 512 embedded in a substrate. One end of the extraction electrode 512 is connected to a pressure-sensitive component and the other end of the extraction electrode 512 is connected to one end of the first lead post 511, and the other end of the first lead post 511 penetrates through the substrate and is electrically connected to the first signal output structure. The extraction electrode can be arranged at a junction of the pressure-sensitive film and the substrate and is separated from the cavity. One end of the extraction electrode is connected to an electrode in the pressure-sensitive component, and the other end of the extraction electrode is connected to the first lead post.

The first lead post is electrically connected to the extraction electrode after penetrating the substrate. In this example, the first lead post does not have a portion exposed in the cavity. As shown in FIG. 1, the first lead post penetrates in the region reg2 of the substrate, and in this case, the first lead post will not be affected by the deformation of the cavity. Accordingly, one end of the first lead post close to the pressure-sensitive film can be electrically connected to the pressure-sensitive component through the extraction electrode.

The extraction electrode can be made of metal materials such as silver and copper. Of course, the materials of the extraction electrode and the pressure-sensitive component can be the same or different, which will not be repeated here.

In an example, the extraction electrode can be arranged at the junction of the pressure-sensitive film and the substrate, that is, the junction of the pressure-sensitive film and the substrate is provided with the extraction electrode, and opposite sides of the extraction electrode are connected to the pressure-sensitive film and the substrate, respectively. Alternatively, in another example, the extraction electrode can also be embedded in the substrate.

The extraction electrode can extend into the cavity and be connected to the pressure-sensitive component in the cavity; or the extraction electrode may not extend into the cavity, but be electrically connected to the pressure-sensitive component located at the junction of the pressure-sensitive film and the substrate.

The first lead post can penetrate through the substrate. The penetration method can be to punch holes on the substrate and pour metal materials in the formed holes to form the first lead post. The first lead post is hermetically connected to the substrate to ensure the vacuum environment of the cavity. The material of the first lead post can be copper, gold, silver, aluminum, and the like, which is not limited here. One end of the first lead post close to the cavity is electrically connected to the extraction electrode, and one end of the extraction electrode is connected to the pressure-sensitive component. If the pressure-sensitive component includes a plurality of electrodes, one end of the extraction electrode close to the cavity is electrically connected to the plurality of electrodes. It should be noted that in this case, a plurality of first lead posts and a plurality of extraction electrodes respectively connected to the plurality of first lead posts can be included, so as to provide electrical connections between the respective first signal output structures with the pressure-sensitive components.

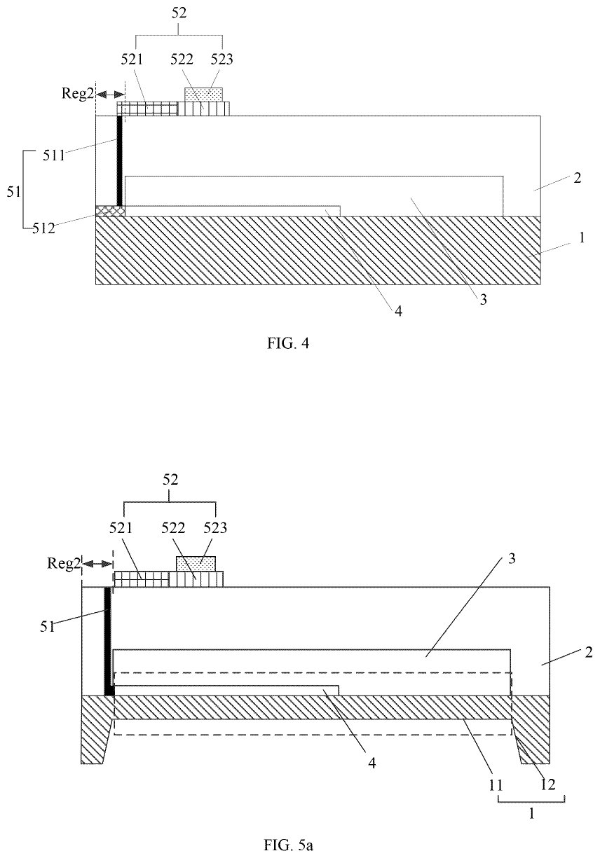

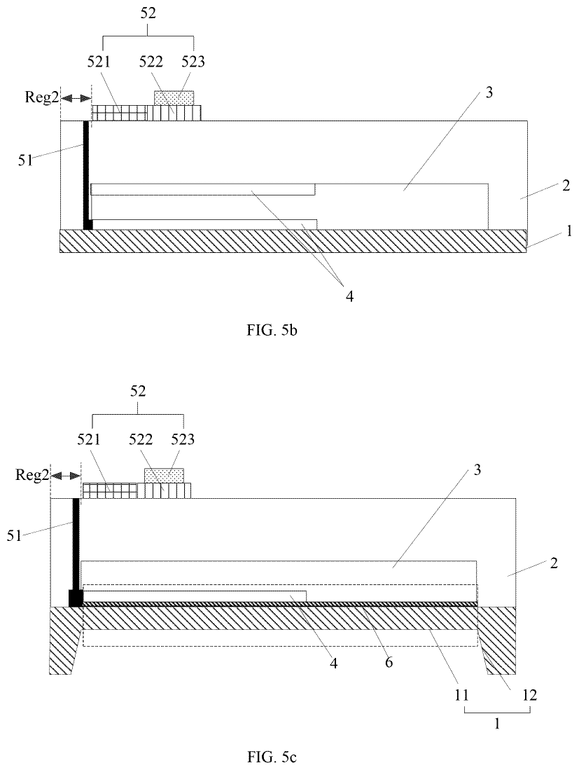

Referring to FIG. 4, FIG. 4 illustrates a schematic cross-sectional structure of another pressure sensing chip. As shown in FIG. 4, the extraction electrode is located at the junction of the pressure-sensitive film and the substrate, and an orthographic projection of the extraction electrode on the substrate does not overlap with the orthographic projection of the cavity on the substrate, that is, the extraction electrode does not have a portion located in the cavity, that is, the extraction electrode does not extend to the cavity. In this case, the pressure-sensitive component may not have a portion located at the junction of the pressure-sensitive film and the substrate; or the pressure-sensitive component can include a portion extending to the junction of the pressure-sensitive film and the substrate.

As shown in FIG. 4, the orthographic projection of the pressure-sensitive component on the substrate may have no overlap with the substrate and be covered by the orthographic projection of the cavity on the substrate. An electrical connection position between the pressure-sensitive component and the extraction electrode can be an edge position of the cavity. The extraction electrode can completely cover a connection region between the pressure-sensitive film and the substrate, or partially cover the connection region between the pressure-sensitive film and the substrate. FIG. 4 illustrates the situation of full coverage, and the connection method between the first lead post and the extraction electrode can be welding, overlapping, or the like.

The size of the extraction electrode in the normal direction of the plane of the pressure-sensitive film can be the same as the size of the pressure-sensitive component in the normal direction of the plane of the pressure-sensitive film, that is, a height of the extraction electrode and a height of the pressure-sensitive component can be the same, and in this case, the pressure-sensitive component and the extraction electrode can be arranged on the same layer. In this case, a step difference between the pressure-sensitive component and the extraction electrode can be reduced. When the pressure-sensitive film is hermetically connected to the substrate, the extraction electrode and the pressure-sensitive component can be used as an alignment reference, and the pressure-sensitive film and the substrate can be packaged after aligning the extraction electrode and the pressure-sensitive component, thereby improving the electrical contact performance and reducing the manufacturing difficulty.

Alternatively, in an example, the size of the extraction electrode in the normal direction of the plane of the pressure-sensitive film can be less than the size of the pressure-sensitive component in the normal direction of the plane of the pressure-sensitive film, that is, the height of the extraction electrode is less than the height of the pressure-sensitive component. Alternatively, the size of the extraction electrode in the normal direction of the plane of the pressure-sensitive film can be greater than the size of the pressure-sensitive component in the normal direction of the plane of the pressure-sensitive film, that is, the height of the extraction electrode is greater than the height of the pressure-sensitive component.

In this example, since the first signal output structure uses the extraction electrode, and the extraction electrode can be separated from the cavity, the extraction electrode is limited by the pressure-sensitive film and the substrate, and will not be affected by the pressure change of the cavity. In this case, the first lead post does not include the portion exposed in the cavity, and thus the first lead post will not be affected by the pressure change in the cavity. At the same time, the airtightness of the cavity will not be affected, and thus the sealing performance of the pressure sensing chip can be improved, and the pressure-sensitive component will not be affected by the lead structure in the process of converting the deformation signals of the pressure-sensitive film into the electrical signals, thereby ensuring the detection sensitivity.

In some exemplary embodiments, the orthographic projection of the pressure-sensitive component on the substrate is located within the orthographic projection of the cavity on the substrate; or the orthographic projection of the pressure-sensitive component on the substrate overlaps with the orthographic projection of the cavity on the substrate.

In this example, the pressure-sensitive component can be completely located in the vacuum cavity, or the pressure-sensitive component can overlap with the cavity. In the case where the pressure-sensitive component can overlap with the cavity, the pressure-sensitive component can overlap with the cavity and the pressure-sensitive film at the same time; or the pressure-sensitive component can overlap with the cavity, the substrate and the pressure-sensitive film at the same time.

When all the pressure-sensitive components are located in the cavity, the pressure-sensitive components can be completely protected inside the cavity, on the one hand, the protection of the pressure-sensitive components can be improved; and on the other hand, the bonding difficulty between the pressure-sensitive film and the substrate can be reduced, that is, when bonding, the influence of the bonding method on the sensitivity of the pressure-sensitive component can be ignored.

In some exemplary embodiments, the pressure-sensitive components can be capacitive pressure-sensitive components or resistive pressure-sensitive components. The pressure-sensitive components can include a plurality of electrodes, all of which can be arranged on a side of the pressure-sensitive film or on both the pressure-sensitive film and the substrate. That is, the pressure-sensitive components can all be located on the side of the pressure-sensitive film close to the substrate, or the pressure-sensitive components can be located on opposite sides of the cavity. For example, the pressure-sensitive components can be distributed on the opposite sides of the cavity in a target direction, where the target direction is a vertical direction that the substrate towards the pressure-sensitive film.

Therefore, according to different layout methods of the pressure-sensitive components, the pressure-sensitive components can generate electrical signals corresponding to the layout methods in response to the deformation of the pressure-sensitive film, for example, resistance signals, capacitance signals, resonance signals, and the like. For example, when the pressure-sensitive components are all arranged on one side of the pressure-sensitive film, the pressure-sensitive components can generate resistance signals or resonance signals in response to the deformation of the pressure-sensitive film; and when the pressure-sensitive components are distributed on opposite sides of the cavity, the pressure-sensitive components can generate capacitance signals in response to the deformation of the pressure-sensitive film.

Specifically, regardless of the distribution method, the pressure-sensitive component can include a structure located on the side of the pressure-sensitive film close to the substrate. Therefore, in order to make the pressure-sensitive film deform more sensitively with the pressure, the whole pressure-sensitive film can be thinned, that is, the whole pressure-sensitive film is a relatively thin film layer.

In some embodiments, in order to ensure the structural stability of the pressure sensing chip, the pressure-sensitive film can be partially thinned. The pressure-sensitive film can include a thinned region 11 and a non-thinned region 12 adjacent to the thinned region 11. A thickness of the thinned region is less than a thickness of the non-thinned region 12, so that the thinned region can deform sensitively in response to the applied pressure.

An orthographic projection of the thinned region on the substrate overlaps with the orthographic projection of the cavity on the substrate.

Specifically, the thinned region can constitute a cavity wall of the cavity. Some or all of the elements in the pressure-sensitive component are arranged on a side of the thinned region close to the cavity.

In this example, the thinned region can be arranged on the pressure-sensitive film. The thinned region can form a cavity wall of the cavity, and thus the orthographic projection of the thinned region on the substrate can cover the orthographic projection of the cavity on the substrate. Alternatively, the thinned region can be a partial region of a cavity wall of the cavity, and thus the orthographic projection of the thinned region on the substrate can partially overlap with the orthographic projection of the cavity on the substrate, for example, the orthographic projection of the thinned region on the substrate is covered by the orthographic projection of the cavity on the substrate; or the orthographic projection of the thinned region on the substrate can intersect with the orthographic projection of the cavity on the substrate.

The thickness of the non-thinned region on the pressure-sensitive film can range from 200 μm to 700 μm, and the thickness of the thinned region on the pressure-sensitive film can range from 5 μm to 100 μm. Specifically, the thickness of the non-thinned region can be 200 μm, 700 μm, or a thickness between 200 μm and 700 μm, for example, 500 μm, 400 μm or 600 μm. The thickness of the thinned region may be 5 μm, 100 μm or a thickness between 5 μm and 100 μm, for example, 10 μm, 50 μm, 40 μm or 60 μm.

In an example, specifically, the thinned region can be surrounded by non-thinned regions, or the thinned region can be partially surrounded by non-thinned regions, that is, some edges of the thinned region are surrounded by non-thinned regions, while other edges do not have non-thinned regions. Of course, in the case where the thinned regions are enclosed by all the non-thinned regions, the protection of the non-thinned regions to the thinned regions can be improved.

If the pressure-sensitive film includes the thinned region and the non-thinned region, and the thickness of the thinned region and the thickness of the non-thinned region are different, a groove will be formed on a side of the pressure-sensitive film, and a surface of the other side of the pressure-sensitive film may be flush or may not be flush. When the surface of the other side of the pressure-sensitive film is not flush, there are grooves on opposite sides of the pressure-sensitive film. In this case, when the pressure-sensitive film is hermetically connected to the substrate, three side walls of the cavity can respond to the pressure of the external environment, thereby improving the flexibility in packaging the pressure-sensitive chip.

On the side of the pressure-sensitive film close to the cavity, the surface of the thinned region and the surface of the non-thinned region of the pressure-sensitive film can be flush to reduce the difficulty of sealing connection. On the side of the pressure-sensitive film away from the cavity, since the thickness of the thinned region and the thickness of the non-thinned region are different, the surface of the thinned region and the surface of the non-thinned region are not flush. Of course, in some other embodiments, the surface of the thinned region and the surface of the non-thinned region of the pressure-sensitive film are not flush on the side of the pressure-sensitive film close to the cavity; while the surface of the thinned region and the surface of the non-thinned region of the pressure-sensitive film are flush on the side of the pressure-sensitive film away from the cavity. In this case, the thinned region can be used as a complete cavity wall of the cavity, and the part of the non-thinned region close to the cavity can be used as a side wall of the cavity, that is, the cavity can be a groove formed by the thinning of the pressure-sensitive film.

The thickness of the substrate can be greater than the thickness of the thinned region, or further, greater than the thickness of the non-thinned region, so as to ensure the structural rigidity of the substrate to the first signal output structure. The whole substrate can also be thinned, so that the thickness of the substrate can be slightly equal to the thickness of the thinned region, thereby reducing the overall size of the pressure sensing chip.

In a further example, an orthographic projection of the non-thinned region on the substrate overlaps with the orthographic projection of the cavity on the substrate, and an orthographic projection of the thinned region on the substrate is covered by the orthographic projection of the cavity on the substrate. In this case, as shown in FIG. 5a, the thinned region can be surrounded by the non-thinned region, and the orthographic projection of the pressure-sensitive component on the substrate can overlap with both the orthographic projection of the non-thinned region and the orthographic projection of the thinned region on the substrate. In this case, the non-thinned region can provide some support for the pressure-sensitive component and the cavity, thereby ensuring the structural stability of the pressure sensing chip.

Referring to FIG. 5a and FIG. 5b, FIG. 5a and FIG. 5b illustrate schematic cross-sectional structures of two pressure sensing chips, respectively. As shown in FIG. 5a, a partial region of the pressure-sensitive film is thinned, and the surface of the pressure-sensitive film on a side away from the cavity is not flush, while the surface of the pressure-sensitive film on a side close to the cavity is flush. The thinned region of the pressure-sensitive film forms a bottom wall of the cavity, and all electrodes in the pressure-sensitive component can be arranged on the thinned region, or some electrodes can be arranged on the thinned region. FIG. 5a shows the situation where the pressure-sensitive component is all located on the thinned region.

As shown in FIG. 5b, if the whole region of the pressure-sensitive film is thinned, the thickness of the pressure-sensitive film is less than the thickness of the substrate, and all elements in the pressure-sensitive component can be arranged on the thinned region, or some elements can be arranged on the thinned region. FIG. 5b shows the situation where some elements in the pressure-sensitive component are located on the thinned region and the remaining elements are located on the side of the substrate close to the cavity.

Of course, in the case where the whole region of the pressure-sensitive film is thinned, all the elements of the pressure-sensitive component can be arranged on the thinned region.

In a further example of this embodiment, referring to FIG. 5c, FIG. 5c illustrates a schematic cross-sectional structure of another pressure sensing chip. As shown in FIG. 5c, an insulating layer 6 can be further provided on the pressure-sensitive film to avoid temperature and other factors affecting the sensitivity of the pressure-sensitive component. The whole insulating layer can cover the pressure-sensitive film, or only cover the thinned region located in the cavity (in this case, the thinned region is the partial region of the cavity wall of the cavity), or cover a region on one side of the pressure-sensitive film covered by the cavity. FIG. 5c shows the situation where the insulating layer covers the region on the side of the pressure-sensitive film covered by the cavity. Elements located on the pressure-sensitive film in the pressure-sensitive component can be located on the side of the insulating layer close to the cavity.

In this example, the insulating layer can be located on the side of the thinned region close to the cavity. Since the thickness of the thinned region is relatively small, it is easily affected by external temperature in practice, and it is easy to cause the problem of poor insulation performance. Therefore, the insulating layer can be used to insulate the elements in the pressure-sensitive component and reduce the influence of external environmental temperature on the deformation of the cavity. When the whole insulating layer covers the pressure-sensitive film, the insulating layer can minimize the influence of the external environmental temperature on the deformation of the cavity, so that the whole pressure sensing chip is not easily affected by the external environmental temperature.

Specifically, the insulating layer can be made of silicon dioxide materials, thereby forming a silicon oxide insulating layer. In this case, the material of the pressure-sensitive film can be silicon, thereby reducing the process difficulty of forming the silicon oxide insulating layer on the pressure-sensitive film. The thickness of the insulating layer can be relatively small, for example, the thickness of the insulating layer can be a micrometer-scale thickness, thereby reducing the resistance of the insulating layer to the pressure of the media to be measured, so that the pressure of the media to be measured can all reach the cavity.

Of course, in some specific implementations, an insulating layer can also be arranged on the side of the substrate close to the cavity. The material of the insulating layer can be silicon dioxide materials or other types of insulating materials, and the thickness of the insulating layer can also be a micrometer-scale thickness. Specifically, the thickness of the insulating layer is less than the thickness of the above-mentioned thinned region, for example, the thickness of the insulating layer can be 1 μm; or the thickness of the insulating layer can be a nanoscale thickness. Specifically, the thickness of the insulating layer can be set according to the actual situation, thereby ensuring the insulation of the elements (elements in the pressure-sensitive component) arranged on one side of the substrate.

As mentioned above, according to the principle of pressure chips, pressure sensors can be classified into four main types such as piezoresistive, capacitive, resonant and piezoelectric. In the following exemplary embodiments, several types of pressure sensing chips will be introduced.

First, referring to FIG. 6a, FIG. 6a illustrates a schematic cross-sectional structure of a piezoresistive pressure sensing chip. As shown in FIG. 6a, in the piezoresistive pressure sensing chip, the pressure-sensitive component can include a first electrode 41 and a second electrode 42. The first electrode and the second electrode are configured to convert a deformation of the pressure-sensitive film into a resistance signal, and the first electrode and the second electrode are both arranged on a side of the pressure-sensitive film close to the cavity.

In this example, the first electrode and the second electrode can be force sensitive resistors, which are configured to produce a change in resistance when the cavity deforms, so that this change in resistance will cause a change in voltage or current in a circuit where the resistance is located. Therefore, the pressure sensing chip can be a piezoresistive sensing chip. The metal materials of the first electrode and the second electrode can be gold, platinum, aluminum, and the like. There is a gap between the first electrode and the second electrode, and a thickness of the first electrode and a thickness of the second electrode can be a micrometer-scale thickness or a sub micrometer-scale thickness.

As shown in FIG. 6a, the first electrode and the second electrode are both arranged on one side of the pressure-sensitive film close to the cavity. In the case where the pressure-sensitive film has a thinned region, the thinned region can be a partial region of the pressure-sensitive film, and the thickness of the thinned region is a millimeter-scale thickness, and the first electrode and the second electrode can be both arranged on one side of the thinned region close to the cavity. An insulating layer is formed on one side of the pressure-sensitive film close to the cavity. The whole insulating layer can cover the pressure-sensitive film, and the first electrode and the second electrode can be arranged on one side of the insulating lay close to the cavity.

In this example, since the pressure-sensitive component includes a first electrode and a second electrode, and the first electrode and the second electrode are both arranged on one side of the pressure-sensitive film close to the cavity, for the first electrode and the second electrode, each of the first electrode and the second electrode corresponds to a first signal output structure. The first signal output structure can include a metal binding region, a metal transition region and a metal wire. The lead structure can include an extraction electrode and a first lead post. The extraction electrode is located on a junction of the pressure-sensitive film and the substrate, and is separated from the cavity. One end of the extraction electrode is electrically connected to the first electrode (or the second electrode), and the other end of the extraction electrode is electrically connected to the metal binding region through the first lead post. One end of the metal binding region is electrically connected to the metal transition region, and a metal wire is formed on the metal transition region, wherein the metal wire is used for electrically connecting to an external signal processing circuit.

The first signal output structure to which the first electrode and the second electrode are respectively connected can also be electrically connected through the metal binding region, so that a circuit can be formed among the first electrode, the second electrode and the two first signal output structures.

Using the pressure sensing chip in this example, since the first electrode and the second electrode of the pressure-sensitive component are arranged in the cavity, the first electrode and the second electrode are not affected by the media to be measured, and the pressure of the media to be measured can be directly measured, thereby ensuring the service life of the pressure sensing chip.

Next, referring to FIG. 6b, FIG. 6b illustrates a schematic cross-sectional structure of a capacitive pressure sensing chip. As shown in FIG. 6b, in the capacitive pressure-sensing chip, the pressure-sensitive component can include a third electrode 43 and a fourth electrode 44. The third electrode and the fourth electrode are configured to convert a deformation of the pressure-sensing film into a capacitive signal. As shown in FIG. 6b, the third electrode can be arranged on a side of the pressure-sensitive film close to the cavity, the fourth electrode can be arranged on a side of the substrate close to the cavity, and an orthographic projection of the third electrode on the substrate overlaps with the fourth electrode.

In this example, the third electrode and the fourth electrode can be resistors made of metal materials. The third electrode and the fourth electrode are configured such that the capacitance formed between the third electrode and the fourth electrode will change when the cavity deforms. Therefore, the pressure sensing chip can be the capacitive sensing chip. The orthographic projection of the third electrode on the substrate overlaps with the fourth electrode, and the overlapping region can be less than the length of the cavity wall close to the substrate. Of course, the larger the area of the overlapping region, the greater the capacitance change when the cavity deforms, and thus the pressure of the media to be measured can be measured more sensitively.

As shown in FIG. 6b, the whole pressure-sensitive film can be thinned, and the substrate can be formed with a groove, so that the groove can form a cavity after bonding with the pressure-sensitive film. For the third electrode and the fourth electrode, each of the third electrode and the fourth electrode corresponds to a first signal output structure, which can include a metal binding region, a metal transition region and a solder joint. The lead structure includes a first lead post. The first lead post penetrates through the substrate and does not have a portion located in the cavity. The third electrode and the fourth electrode may each have a portion beyond the cavity, that is, a portion of the third electrode is located in the cavity, and the other portion is located outside the cavity and inside the substrate. The first lead post connected to the third electrode needs to penetrate through the whole substrate and then be electrically connected to the portion of the third electrode beyond the cavity. The first lead post connected to the fourth electrode needs to penetrate through a part of the substrate and then be electrically connected to the portion of the fourth electrode beyond the cavity. The solder joint can be spherical metal formed on the metal transition region. Specifically, the solder joint can be a tin ball.

As shown in FIG. 6b, the first signal output structures corresponding to the third electrode and the fourth electrode do not need to be electrically connected, that is, there is no need to conduct between the metal transition regions on the two first signal output structures. The metal binding region on each first signal output structure can cover an end of the first lead post away from the cavity.

In a further exemplary capacitive pressure sensing chip, a spacer 7 and a sealing ring 8 can be further included between the pressure-sensitive film and the substrate. One side of the spacer close to the pressure-sensitive film is sealed with the pressure-sensitive film through the sealing ring, and one side of the spacer close to the substrate is sealed with the substrate through the sealing ring.

Referring to FIG. 6c, FIG. 6c illustrates a schematic cross-sectional structure of another capacitive pressure sensing chip. As shown in FIG. 6c, the whole pressure-sensitive film is thinned, and the substrate is a flat substrate, that is, the substrate does not have a groove area. When the pressure-sensitive film is hermetically connected to the substrate, a spacer and a sealing ring can be used for connection. The opposite sides of the spacer are respectively connected to the pressure-sensitive film and the substrate through sealing rings, that is, one side of the spacer close to the substrate is sealed with the substrate through a sealing ring, and the other side of the spacer close to the pressure-sensitive film is sealed with the pressure-sensitive film through a sealing ring. The material of the spacer can be insulating materials such as glass or ceramics, and the sealing ring can be made of insulating materials such as rubber or metal materials.

The sealing ring is a ring-shaped sealing structure, and the spacer is used to separate the cavity. The orthographic projection of the third electrode on the pressure-sensitive film overlaps with both the orthographic projection of the cavity and the orthographic projection of the spacer on the pressure-sensitive film. The orthographic projection of the fourth electrode on the substrate overlaps with both the orthographic projection of the cavity and the orthographic projection of the spacer on the substrate.

Of course, the packaging form using the spacer and sealing ring can also be applied to the piezoresistive pressure sensing chip, and FIG. 6c only takes the capacitive pressure sensing chip as an example. When using this packaging form, the sealing performance of the cavity can be improved.

Of course, only two examples of pressure sensing chips are listed above. In other embodiments, there may be two main types of chips such as resonant and piezoelectric, and the structures thereof can refer to the structures of the capacitive pressure sensing chip and the piezoresistive pressure sensing chip mentioned above, which will not be repeated here.

Next, two kinds of pressure sensing chips are exemplarily given.

Example A1, as shown in FIG. 6d, a structure of the pressure sensing chip includes a pressure-sensitive film, a substrate, a first signal output structure and a lead structure. The pressure-sensitive film is a silicon substrate and the substrate is a glass substrate. The pressure-sensitive film and the substrate are bonded using anodic bonding process to form a cavity after bonding.

The pressure-sensitive film includes a thinned region and a non-thinned region. The thinned region forms one side of the cavity wall of the cavity, and the orthographic projection of the non-thinned region on the substrate overlaps with the orthographic projection of the cavity on the substrate. A silicon oxide insulating layer is formed on a side of the pressure-sensitive film close to the cavity, and the whole silicon oxide insulating layer covers the pressure-sensitive film. A first electrode and a second electrode spaced apart are formed on a side of the silicon oxide insulating layer close to the cavity, where both the first electrode and the second electrode are located in the cavity.

Each of the first electrode and the second electrode corresponds to a first signal output structure and a lead structure. The first signal output structure includes a metal binding region, a metal transition region and a signal output terminal, and the lead structure includes a first lead post and an extraction electrode, where the signal output terminal is a spherical solder joint arranged on the metal transition region. The metal binding region is arranged between the metal transition regions of the two first signal output structures, and the two metal transition regions are electrically connected through the metal binding region. The thinned region can convert pressure signals into deformation signals, and both the first electrode and the second electrode are force sensitive resistors that can convert the deformation of the thinned region into electrical signals.

The extraction electrode is located on the junction of the pressure-sensitive film and the substrate, and does not extend to the cavity. One end of the extraction electrode is electrically connected to the first electrode and the other end the extraction electrode is electrically connected to the first lead post, so as to transmit the electrical signals on the first electrode to the first lead post. The first lead post does not have a portion exposed in the cavity. The first lead post is an electrical connection structure of the first electrode, and is used to transmit the electrical signals on the extraction electrode to the metal binding region. The metal binding region is also the electrical connection structure of the pressure sensing chip. The metal binding region uses a copper re-distributed layer to transmit the electrical signals on the first lead post to the metal transition region. The metal transition region is composed of multilayer metal films such as adhesion layers, diffusion barrier layers and wetting layers, and has three main functions: 1) the electrical connection structure of the pressure sensing chip transmits the electrical signals on the metal binding region to the spherical solder joint; 2) the bonding layer interconnecting the metal binding region and the spherical solder joint; and 3) preventing atoms of the solder ball material from diffusing to the metal binding region. The spherical solder joint mainly has two functions: 1) an input port and an output port of the whole pressure sensing chip; and 2) a bonding structure for flip chip bonding with the packaging substrate during packaging.

When performing pressure detection on the media to be measured using the pressure sensing chip, a pressure value in the cavity is a reference pressure for the pressure sensing chip to measure the pressure. When a pressure value of the media to be measured is equal to the pressure value in the cavity, the first electrode and the second electrode will not generate the electrical signals, and an output of the pressure sensing chip is zero; and when the pressure value of the media to be measured is greater than the pressure value in the cavity, the output of the pressure sensing chip is an external atmospheric pressure minus the pressure in the cavity.

Unlike the pressure sensing chip shown in FIG. 6a, the signal output terminal in the pressure sensing chip shown in FIG. 6a is a metal wire. When using the pressure sensing chip shown in FIG. 6b, since the signal output terminal is a spherical solder joint, one side of the substrate of the pressure sensing chip can be soldered to the packaging substrate through the spherical solder joint, thereby reducing the packaging difficulty.

Example A2, as shown in FIG. 6e, the structure of the pressure sensing chip includes a pressure-sensitive film, a substrate, a lead structure and a first signal output structure. The pressure-sensitive film is a silicon substrate and the substrate is a glass substrate, the whole pressure-sensitive film is thinned, the substrate is flat, and the pressure-sensitive film and the substrate are bonded through a spacer made of glass materials and a sealing ring. The pressure-sensitive component includes a third electrode and a fourth electrode. The third electrode is arranged on a side of the pressure-sensitive film close to the cavity, and the fourth electrode is arranged on a side of the substrate close to the cavity. In this example, the pressure-sensitive film is also called a movable plate, the substrate is also called a fixed plate, the third electrode can be called a movable plate electrode, and the fourth electrode can be called a fixed plate electrode.

The sealing ring is made of metal materials. The sealing ring is a mechanical connection structure of the pressure sensing chip, and is used to connect the fixed electrode plate, the spacer and the movable plate together to form a cavity. Due to the function of the spacer, the cavity is formed between the pressure-sensitive film and the substrate.

The third electrode is partially located in the cavity and partially located at the junction of the pressure-sensitive film and the substrate. The fourth electrode is partially located in the cavity and partially located at the junction of the pressure-sensitive film and the substrate.

Each of the third electrode and the fourth electrode corresponds to a first signal output structure. The first signal output structure includes a metal binding region, a metal transition region and a signal output terminal. The two first signal output structures can be spaced apart, that is, there is no electrical connection between the two first signal output structures.

The first lead post connected to the third electrode penetrates through the substrate and the spacer and is connected to the third electrode. The first lead post connected to the fourth electrode penetrates through the substrate and is connected to the fourth electrode.

The functions of the metal binding region and the metal transition region can be described with reference to the above example A1. In this example, the signal output terminal is a first bonding bump, which is integrally formed with the metal transition region and made of the same metal materials. During packaging, the signal output terminal can be bonded to the packaging substrate.

When performing pressure detection on the media to be measured using the pressure sensing chip, the capacitance value of the chip is measured by measuring the electrical signals between the movable plate electrode and the fixed plate electrode, so as to determine the pressure of the media to be measured.

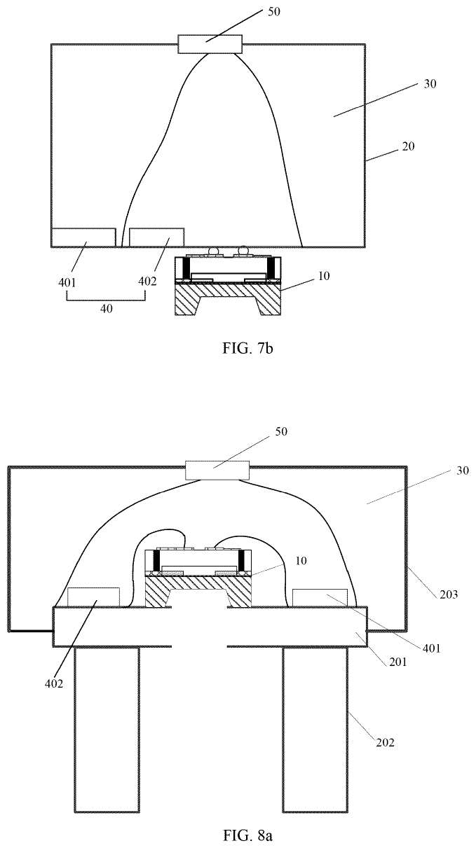

Based on the same inventive concept, the present disclosure also provides a pressure sensor packaged with the pressure sensing chip described above. The pressure sensor includes the above pressure sensing chip and a packaging structure, where the packaging structure is used to package the pressure sensing chip. Referring to FIG. 7a and FIG. 7b, FIG. 7a and FIG. 7b illustrate schematic cross-sectional structures of two pressure sensors. As shown in FIG. 7a and FIG. 7b, the pressure sensor includes the pressure sensing chip shown in any of the above examples and a packaging structure. The packaging structure is used to package the pressure sensing chip and outwardly expose some structures in the cavity of the pressure sensing chip, so that the pressure sensing chip can directly detect the pressure of liquids or corrosive gases.

Specifically, the packaging structure can include a packaging part 20, a second signal output structure 20 and a signal processing circuit 40. The pressure sensing chip can be mounted on the packaging part and electrically connected to the signal processing circuit. The packaging part is provided with a closed cavity 30, and at least the signal processing circuit exists in the closed cavity. The second signal output structure is configured to the packaging part and electrically connected to the signal processing circuit, and is configured to outwardly output electrical signals processed by the signal processing circuit.

A target region 101 on a side of the pressure-sensitive film of the pressure sensing chip away from the cavity can be outwardly exposed, after the target region contacts the media to be measured, the pressure of the media to be measured is transmitted to the pressure-sensitive film, so that the pressure-sensitive film deforms under the support of the cavity.

As shown in FIG. 7a, the pressure sensing chip can be welded to the packaging part, or bonded to the packaging part, or stuck to the packaging part. The pressure sensing chip can be located in a closed cavity, or as shown in FIG. 7b, the pressure sensing chip may not be located in the closed cavity. The target region can be the whole region of a side of the pressure-sensitive film away from the cavity, or can only refer to an orthographic projection region of the cavity on a side of the pressure-sensitive film away from the cavity. In order to protect the first signal output structure on the pressure sensing chip, the first signal output structure may not be exposed to the external environment.

In an example, the packaging part can be a rectangular frame structure with a hollow inside, and can be supported by metal materials such as stainless steel, alloy materials, and the like that are not easily corroded. A bearing surface inside the packaging part is packaged with a signal processing circuit, which can be electrically connected to the first signal output structure of the pressure sensing chip. Specifically, the signal processing circuit can be electrically connected to the signal output terminal on the first signal output structure, and the connection method can be bonding, coupling, welding or overlapping, and the like, which will not be repeated here. Specifically, the signal processing circuit can include an application specific integrated circuit (ASIC) chip 401, a thick film circuit (not shown in the figures) and a resistance-capacitance component 402. The thick film circuit can be formed on a side of the packaging part close to the closed cavity, and the thick film circuit can be a printed circuit. In practice, the thick film circuit can be made of printed circuit boards. The ASIC chip is electrically connected to the resistance-capacitance component through the thick film circuit, and the signal output terminal on the first signal output structure can be electrically connected to the thick film circuit, so that electrical signals output by the pressure-sensitive component of the pressure sensing chip are introduced into the thick film circuit, and then input into the circuit formed by the ASIC chip and the resistance-capacitance component through the thick film circuit.

The ASIC chip is mainly used for functions such as filtering, amplifying and compensating. The resistance-capacitance component is used for circuit processing, adjusting components, filtering out interference signals and improving the overall performance of the circuit. The electrical signals output by the pressure-sensitive component are input into the circuit formed by the ASIC chip and the resistance-capacitance component through the thick film circuit, after interference signals in the electrical signals are filtered by the resistance-capacitance component, the electrical signals are filtered, amplified and compensated by the ASIC chip, and then output to the second signal output structure.

The second signal output structure is electrically connected to the signal processing circuit. Specifically, the second signal output structure can be connected to an output terminal of the ASIC chip through AF wires 9 located in the closed cavity.

Using the pressure sensor of this embodiment, since the packaging part is provided with the closed cavity, the signal processing circuit for processing signals output by the pressure sensing chip is located in the closed cavity, so that the signal processing circuit cannot be affected by the external environment, thereby ensuring the electrical performance of the signal processing, and improving the service life of the whole pressure sensor. In addition, since the target region on the side of the pressure-sensitive film in the pressure sensing chip away from the cavity is outwardly exposed, the media to be measured can directly contact the side of the pressure-sensitive film away from the cavity, thereby realizing direct measurement of the media to be measured.

In some embodiments, the pressure sensing chip as a whole can be located outside the closed cavity, and the first signal output structure is connected to the packaging part.

Alternatively, the pressure sensing chip as a whole is located in the closed cavity. The pressure-sensitive film is hermetically connected to the packaging part, and the packaging part is provided with a through hole allowing the media to be measured to flow in, and the through hole is connected to the pressure-sensitive film.

For example, the pressure sensing chip can be located in the closed cavity 30, as shown in FIG. 7a, a target region of the pressure-sensitive film on the side away from the cavity needs to be outwardly exposed. At this time, the packaging part can have a notch that exposes the target region. When the pressure sensing chip is mounted on the packaging structure, the pressure sensing chip can be mounted at the notch, so that the pressure sensing chip can be enclosed with the packaging part to form the closed cavity, and only the pressure-sensitive film is outwardly exposed. The pressure-sensitive film of the pressure sensing chip can be hermetically connected to a side of the packaging part close to the closed cavity, where the pressure-sensitive film includes a thinned region and a non-thinned region. Specifically, the thinned region of the pressure-sensitive film can be outwardly exposed, and the non-thinned region is hermetically connected to a side of the packaging part close to the closed cavity. In this way, the target region is exposed to the external environment, and the first signal output structure on one side of the substrate is not exposed to the external environment, but is located in the closed cavity, and thus the signal processing circuit and the first signal output structure can be protected and the service life of the pressure sensing chip can be improved. Of course, if the whole pressure-sensitive film is thinned, it can also be that a partial region of the pressure-sensitive film is hermetically connected to one side of the packaging part close to the closed cavity, and the orthographic projection region of the cavity is outwardly exposed.

The pressure sensing chip can be located outside the closed cavity, as shown in FIG. 7b, one side of the substrate away from the cavity is hermetically connected to the side of the packaging part away from the closed cavity. Specifically, the first signal output structure can be connected to the packaging part. The pressure-sensitive film can be completely exposed to the outside, but in some cases, the pressure-sensitive film can also be exposed only in the target region of the cavity. In this way, the connection between the pressure sensing chip and the packaging part can be simplified. For example, the signal output terminal on the first signal output structure can be a spherical solder joint, and the electrical connection between the first signal output structure and the packaging part can be realized through the spherical solder joint. In this example, a protective layer can be provided to protect the first signal output structure, and the protective layer is made of insulating materials, so as to protect the first signal output structure from exposure to the external environment and from the corrosion of the media to be measured.

In some embodiments, in order to reduce the packaging cost and volume of the packaging structure, the packaging part can be formed by splicing a plurality of components, including, for example, a component for mounting the pressure sensing chip, a component for supporting the pressure sensing chip, and a component for sealing. In a specific implementation, the packaging part can include a mounting part 201, a supporting part 202 and a sealed housing 203.

The pressure sensing chip and the signal processing circuit are mounted on the same side or opposite sides of the mounting part. The supporting part is connected to the mounting part and used to support the mounting part. The sealed housing is hermetically connected to the supporting part to form a closed cavity with the supporting part; or the sealed housing is hermetically connected to the mounting part to form a closed cavity with the supporting part, and the second signal output structure is connected to the sealed housing.

The mounting part can be made of insulating materials such as ceramics. The mounting part can be a plate-shaped structure to provide a flat surface for mounting the pressure sensing chip and the signal processing circuit. The side of the mounting part where the signal processing circuit is mounted is located in the closed cavity, and the pressure sensing chip and the signal processing circuit can be located on the same side or on opposite sides of the mounting part. When the pressure sensing chip and the signal processing circuit are located on the same side, the side of the pressure-sensitive film of the pressure sensing chip away from the cavity is connected to the mounting part, so that the pressure sensing chip can be located in the closed cavity, and the mounting part can be provided with a notch for the target region of the pressure sensing chip to be outwardly exposed, so that the first signal output structure of the pressure sensing chip is located in the closed cavity, and the target region is exposed at the notch. When the pressure sensing chip and the signal processing circuit are located on the opposite sides, the side of the substrate of the pressure sensing chip away from the cavity is connected to the mounting part. In this case, the mounting part does not have a notch outwardly exposed, and the pressure sensing chip can be located outside the closed cavity.

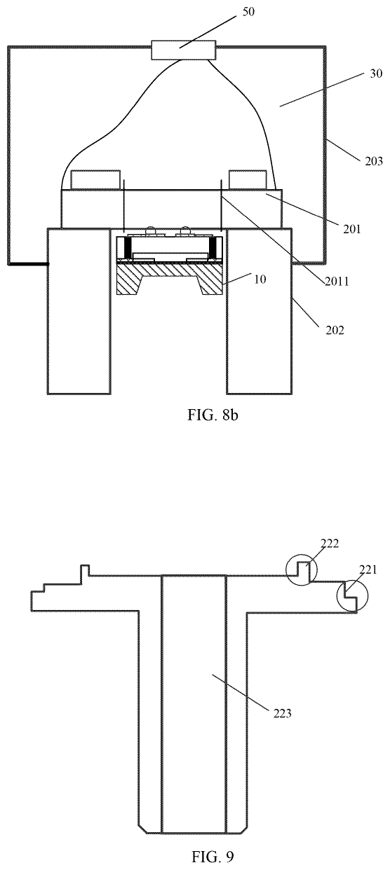

Referring to FIG. 8a to FIG. 8b, FIG. 8a and FIG. 8b respectively illustrate schematic cross-sectional structures of two pressure sensors. As shown in FIG. 8a, the supporting part can be connected to one side of the mounting part away from the closed cavity and used to support the mounting part. The supporting part can be made of metal materials such as stainless steel. The supporting part can include one or more supporting parts to provide support for the mounting part and provide a channel to expose the target region.

The sealed housing can be hermetically connected to the supporting part or the mounting part. FIG. 8a illustrates a schematic diagram of the sealed housing being hermetically connected to the mounting part. The sealed housing can also be made of metal materials or ceramic materials. Of course, in order to realize the connection between the sealed housing and the mounting part, a position where the mounting part is connected to the sealed housing can be coated with metal materials for welding connection with the sealed housing. Of course, the metal material of the sealed housing and the metal material on the mounting part can be the same, so as to reduce the welding difficulty.

The sealed housing can be hermetically connected to the supporting part, and FIG. 8b illustrates a schematic diagram schematic diagram of the sealed housing being hermetically connected to the mounting part. The sealed housing can also be made of metal materials, and the metal material of the sealed housing and the metal material of the supporting part can be the same, so as to reduce the welding difficulty, as shown in FIG. 8b.

Accordingly, in some embodiments, since the first signal output structure of the pressure sensing chip may or may not be located in the closed cavity, the connection method between the pressure sensing chip and the mounting part can also be as follows. As shown in FIG. 8a, the pressure sensing chip is located in the closed cavity, and the specific implementation is that one side of the pressure-sensitive film of the pressure sensing chip away from the cavity is connected to one side of the mounting part close to the closed cavity; the first signal output structure of the pressure sensing chip is electrically connected to the signal processing circuit through metal wires, in this case, the mounting part is provided with a first through hole 224 connected to the outside, and a size of the first through hole 224 can be less than a size of the cavity. Alternatively, as shown in FIG. 8b, the pressure sensing chip is located outside the closed cavity, and the specific implementation method is that the first signal output structure of the pressure sensing chip is connected to one side of the mounting part away from the closed cavity, and the first signal output structure of the pressure sensing chip is welded to one side of the mounting part away from the closed cavity through a spherical solder joint, so as to realize the electrical connection between the first signal output structure and the signal processing circuit. The mounting part is penetrated with a second metal lead post, one end of the second metal lead post is electrically connected to the first signal output structure, and the other end of the second metal lead post is electrically connected to the signal processing circuit.

As shown in FIG. 8b, thick film circuits can be formed on both the side of the mounting part away from the closed cavity and the side of the mounting part close to the closed cavity. On the side of the mounting part away from the closed cavity, the electrical signals of the first signal output structure are introduced to the second metal lead post through a thick film circuit, and the second metal lead post introduces the electrical signals to the thick film circuit through the side of the mounting part close to the closed cavity and then to the signal processing circuit through the thick film circuit.

Using the structure of this embodiment, since the packaging part is composed of the mounting part, the supporting part and the sealed housing, when forming the packaging part, the three parts can be connected in turn according to a certain packaging order, thereby reducing the assembly difficulty. In addition, since the mounting part, the supporting part and the sealed housing can be made of simple and easily available materials, the packaging cost can also be reduced.

In some exemplary embodiments, the supporting part can be used to support the mounting part, that is, the pressure sensing chip and the carrier structure of the mounting part. Since the sealed housing can be connected to the supporting part to form a closed cavity, and the supporting part is connected to the mounting part, the supporting part can include a structure connected to the sealed housing and a structure connected to the mounting part. The structure connected to the sealed housing can form a closed cavity with the sealed housing, and the structure connected with the mounting part can be used as the carrier of the pressure sensing chip.

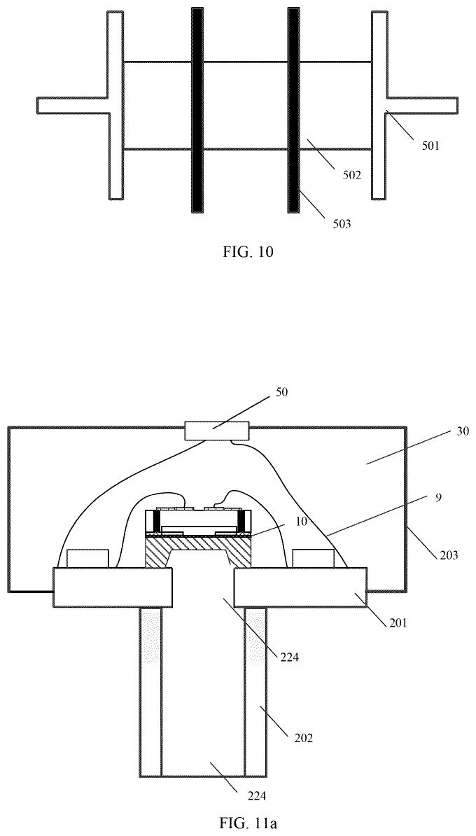

Referring to FIG. 9, FIG. 9 illustrates a schematic structural diagram of a supporting part. As shown in FIG. 9, the supporting part can include a T-shaped supporting part, and a supporting surface of the T-shaped supporting part includes a first mounting table and a second mounting table. The first mounting table is located outside the second mounting table, and the sealed housing is connected to the first mounting table.

The T-shaped supporting part is provided with a second through hole 223 penetrating therethrough, and the mounting part is connected to the second mounting table and/or side walls of the second through hole 223. One end of the second through hole allows the media to flow in, and the other end of the second through hole exposes the target region. The second through hole can be realized by drilling holes in the supporting part, and the second through hole can be cylindrical or rectangular, which will not be repeated here.

For example, the supporting part can form a T-shaped structure with a supporting surface. The supporting surface can be provided with a first mounting table and a second mounting table, as shown in FIG. 9. The second mounting table is a welding structure between the supporting part and the mounting part, and the first mounting table is a welding structure between the supporting part and the sealed housing. Specifically, the second mounting table can include two bosses oppositely arranged on the supporting surface, and a region between the two bosses is used to mount the mounting part. The first mounting table can include two bosses oppositely arranged on the supporting surface. The two bosses are located outside the two bosses of the second mounting table, and a height of the first mounting table is less than a height of the second mounting table. When mounting the mounting part to the second mounting table, the mounting part can be welded to the two bosses of the second mounting table; and when the sealed housing is mounted to the first mounting table, the sealed housing can be welded to two bosses of the first mounting table.

The T-shaped supporting part can include a second through hole penetrating therethrough. The second through hole penetrates along a symmetry axis of the T-shaped supporting part, and a diameter of the second through hole can be greater than a dimension of the cavity in a length direction, that is, an orthographic projection of the second through hole on the pressure-sensitive film of the pressure sensing chip covers the orthographic projection of the cavity on the pressure-sensitive film. The second through hole is used to expose the pressure-sensitive film to the external environment. Specifically, the second through hole can penetrate to the second mounting table, so that when the pressure sensing chip is mounted to the mounting part and the mounting part is mounted to the second mounting table, the target region of the pressure sensing chip can be exposed through the second through hole.

Due to the existence of the second through hole, the pressure-sensitive film of the pressure sensing chip can be connected to the mounting part, or the first signal output structure of the substrate can be connected to the mounting part, and thus a mounting position of the mounting part on the supporting part can be flexibly set. For example, when the pressure sensing chip as a whole is located in the closed cavity, the mounting part can be mounted on a second mounting boss. In this case, the pressure-sensitive film of the pressure sensing chip is connected to the mounting part, and the mounting part can be provided with a hole connected to the second through hole. For another example, when the pressure sensing chip as a whole is located outside the closed cavity, the first signal output structure of the pressure sensing chip is connected to one side of the mounting part away from the closed cavity, and thus the mounting part may not be provided with a through hole. For another example, when the pressure sensing chip as a whole is located outside the closed cavity, the mounting part can also be mounted on the second mounting boss and connected to the side walls of the second through hole. In this case, it is only necessary to ensure that the structure on one side of the mounting part close to the closed cavity is sealed in the closed cavity and the pressure-sensitive film of the pressure sensing chip is exposed in the second through hole.

The materials of two boss structures of the first mounting table can be the same as the material of the sealed housing, and the materials of two boss structures of the second mounting table can be the same as the material of the mounting part.

Using this supporting part, the stability of the packaging structure for packaging the pressure sensing chip can be improved due to the T-shaped structure of the supporting part.

In some exemplary embodiments, the second signal output structure is electrically connected to the signal processing circuit. In order to maintain the sealing performance of the closed cavity, the second signal output structure can be arranged on the packaging part. For example, the second signal output structure can be hermetically connected to the packaging part, and the sealing connection can be welding, bonding, or the like. Accordingly, the second signal output structure can include a component connected to the packaging part and a component connected to the signal processing circuit. Referring to FIG. 10, FIG. 10 illustrates a schematic structural diagram of a second signal output structure. As shown in FIG. 10, the second signal output structure can include a connector 502, an insulator 502 and a second lead post 503.

The connector is hermetically connected to the packaging part, and both ends of the insulator are respectively connected to the connector. The second lead post penetrates through the insulator, and one end of the second lead post close to the closed cavity is electrically connected to the signal processing circuit through the second metal lead.

In this embodiment, the connector can be connected to the packaging part. Specifically, when the packaging part includes a mounting part, a supporting part and a sealed housing, the connector can be connected to the sealed housing. In general, there are two connectors, and the insulator can be connected to the two connectors, respectively. The second lead post penetrates through the insulator and is electrically connected to the signal processing circuit located in the closed cavity. In an example, the second lead post can be electrically connected to the signal processing circuit through AF wires 9. The AF wires are high temperature wires with excellent corrosion resistance, oil resistance, strong acid resistance, strong alkali resistance, strong oxidant resistance, and the like, and can be used for pressure measurement of corrosive media to be measured.

As shown in FIG. 10, the connector can be a T-shaped connector, a supporting surface of the T-shaped connector is connected to the insulator, and a convex part of the T-shaped connector is connected to the sealed housing. The connection method with the insulator can be welding or bonding. The T-shaped connector can be made of metal materials, which can be the same as the metal material of the sealed housing, thereby reducing the welding difficulty of the T-shaped connector and the sealed housing.

The insulator can be ceramic materials or polymer materials, which is not limited here and can be used for insulating the second lead post.

The second lead post can be made of copper, silver or aluminum. When forming the second lead post, a through hole penetrating therethrough can be formed on the insulator, and then copper liquid can be poured into the through hole to form the second lead post.

By using the second signal output structure, the second signal output structure and the packaging part can be independent components, and the second signal output structure can also be formed by welding a plurality of components. Therefore, when packaging the pressure sensing chip, a certain packaging sequence can be performed, for example, mounting the pressure sensing chip and the packaging part first, and then sealing the second signal output structure and the packaging part, thereby reducing the packaging difficulty of the pressure sensing chip. In addition, the material of the second signal output structure is easily obtained, thereby reducing the manufacturing cost.

Based on the sealed housing, the mounting part, the supporting part and the second signal output structure, there are many options for packaging the pressure sensing chip. In an option C1, the pressure sensing chip can be located in a closed cavity together with the signal processing circuit. In this case, the closed cavity can be used to protect the first signal output structure and the signal processing circuit on the pressure sensing chip, so as to prevent the first signal output structure from contacting with the external environment and only expose the target region to the external environment, thereby improving the electrical protection of the pressure sensing chip and prolonging the service life. Since the pressure-sensitive film and the first signal output structure are located on opposite sides of the pressure sensing chip respectively, and the pressure-sensitive film needs to be exposed to the external environment, when using the packaging method C1, as shown in FIG. 8a, the pressure-sensitive film of the pressure sensing chip needs to be bonded to the mounting part, so that the target region of the pressure-sensitive film can be exposed to the external environment, and the first signal output structure is located in the closed cavity.

In another option C2, the pressure sensing chip may not be located in the closed cavity, and the pressure-sensitive film can be exposed to the external environment. In this case, the first signal output structure on the pressure sensing chip and the signal processing circuit can be located on the opposite sides of the mounting part. Similarly, since the pressure-sensitive film and the first signal output structure are located on the opposite sides of the pressure sensing chip respectively, and the pressure-sensitive film needs to be exposed to the external environment, in this way, the first signal output structure on the pressure sensing chip is directly bonded to the mounting part, so as to realize the electrical connection with the mounting part, and at the same time, the pressure-sensitive film is exposed to the external environment. As shown in FIG. 8b, under the option C2, since the first signal output structure is directly bonded to the mounting part, the difficulty of electrical connection between the pressure sensing chip and the mounting part can be reduced.

Hereinafter, the above methods will be explained separately.

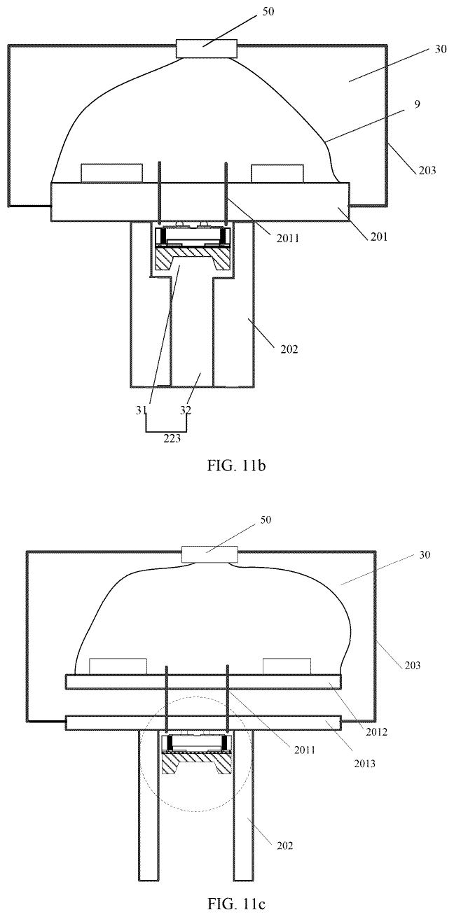

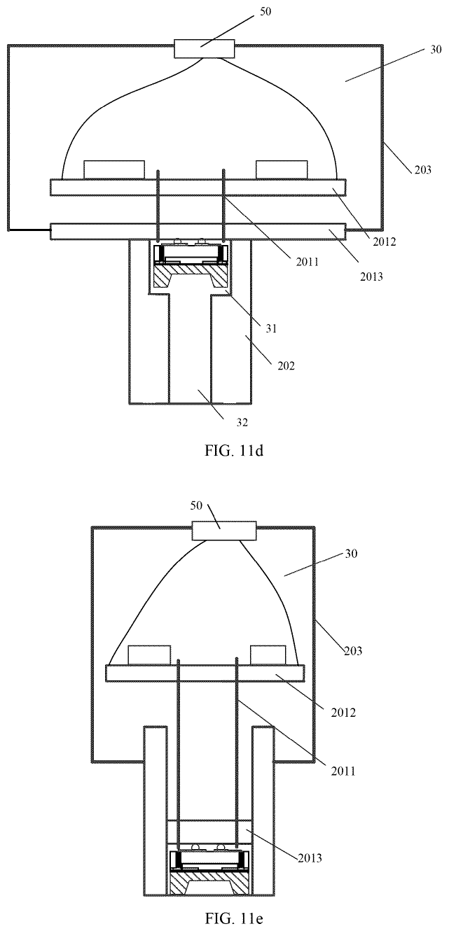

In the above example C1, referring to FIG. 11a, FIG. 11a illustrates a schematic diagram of a packaging structure of a pressure sensing chip. As shown in FIG. 11a, in the structure of the pressure sensor obtained by using the packaging method of the option C1, the pressure sensing chip and the signal processing circuit are located on the same side of the mounting part, one side of the pressure-sensitive film of the pressure sensing chip is bonded to the mounting part, and the pressure sensing chip is electrically connected to the signal processing circuit through metal wires of the first signal output structure.

Each of the mounting part and the supporting part is provided with a first through hole 224 for allowing the media to be measured to flow in. The first through hole 224 is connected to one side of the pressure-sensitive film away from the cavity.

In this example, reference can be made to the description of the example in FIG. 8a. The difference from the example in FIG. 8a is in that a supporting part is used, and a first through hole leading to the target region is formed on the supporting part. Since the pressure-sensitive film is exposed to the external environment by trepanning holes on the supporting part, a periphery of the first through hole is surrounded and protected by the material of the supporting part, thereby avoiding the problem that the packaging structure is greatly affected by the environment due to large-area contact with the media to be measured. The pressure sensing chip can form a sealed structure with the mounting part by means of glass slurry or metal bonding, which is highly reliable and relatively simple in structure. In this case, when the metal wires are electrically connected to the signal processing circuit, the electrical signals can be transmitted through wire bonding.

In a further example of this embodiment, a radius of the first through hole in the mounting part can be the same as a radius of the first through hole in the supporting part, and the radius of the first through hole needs to be less than the size of the cavity of the pressure sensing chip in a radial direction of the supporting part. Therefore, only the pressure-sensitive film in the cavity contacts the external environment, and the degree of protection for other electrical structures of the pressure sensing chip is improved.

In a further example of this embodiment, the radius of the first through hole on the mounting part can be less than the radius of the first through hole opened on the supporting part.

In this embodiment, the diameter of the first through hole on the mounting part needs to be less than a width of the cavity, that is, an orthographic projection of the cavity on a plane of the mounting part covers the first through hole on the mounting part, so as to avoid the problem that other structures of the pressure-sensitive film of the pressure sensing chip contact with the media to be measured and be corroded, thereby improving the protection of the pressure sensing chip. The orthographic projection of the cavity on the plane of the mounting part can be covered by the first through hole on the supporting part, thereby increasing an area of a region allowing liquids to flow in and ensuring the accuracy of pressure detection of the media to be measured.

Referring to FIG. 11b, FIG. 11b illustrates a schematic diagram of a packaging structure of a pressure sensing chip. As shown in FIG. 11b, the packaging method of the option C2 is used, and the pressure sensing chip is located outside the closed cavity, and thus in the structure of the obtained pressure sensor, the pressure sensing chip and the signal processing circuit are located on opposite sides of the mounting part respectively. There is a gap between the pressure sensing chip and the supporting part, and the first signal output structure of the pressure sensing chip on the substrate is bonded to the mounting part. A third lead post 2011 penetrates through the mounting part, one end of the third lead post is connected to the first signal output structure, and the other end of the third lead post is connected to the signal processing circuit.

In this example, reference can be made to the description of the example in FIG. 8b. The difference from the example in FIG. 8b is in that a supporting part is used, and a second through hole 223 leading to the target region is formed on the supporting part. Since the pressure-sensitive film is exposed to the external environment by trepanning holes on the supporting part, a periphery of the second through hole is surrounded and protected by the material of the supporting part, thereby avoiding the problem that the packaging structure is greatly affected by the environment due to large-area contact with the media to be measured.

In this example, the second through hole of the supporting part includes a first region 31 close to the mounting part and a second region 32 away from the mounting part. A size of the first region in a radial direction is greater than a size of the second region in the radial direction, so that the first region and the second region form a T-shaped second through hole, where the pressure sensing chip is located in the first region. Therefore, the first region can provide a mounting environment for the pressure sensing chip and the mounting part. The first region can be regarded as a mounting table for mounting the mounting part and the pressure sensing chip on the supporting part, and a region of the pressure sensing chip except the pressure-sensitive film can be connected to the side wall of the first region, that is, only the pressure-sensitive film of the pressure sensing chip is connected to the second region, in this case, other structures of the pressure sensing chip can be protected from being exposed to the external environment. When the size of the second region is less than the size of the first region, the media to be measured flowing to the pressure sensing chip can be ensured to be concentrated on the pressure-sensitive film, thereby facilitating the pressure detection of the media to be measured.

Of course, as shown in FIG. 11b, there may be a gap between the pressure sensing chip and the hole wall of the first region, and a protective layer is arranged on one side of the mounting part close to the pressure sensing chip to protect the first signal output structure, so that the first signal output structure is not in contact with the external environment.

In this embodiment, since the pressure sensing chip can be welded to the mounting part through the first signal output structure, compared with the structure shown in FIG. 11a, this structure can avoid the problem that the production efficiency is relatively low when the pressure sensing chip and the mounting base are bonded by slurry, thereby improving the production efficiency.

In a further example of this embodiment, as a mounting part for packaging the pressure sensing chip and the signal processing circuit, the carrier of the pressure sensing chip and the component for carrying the signal processing circuit can be separately arranged. For example, the pressure sensing chip and the signal processing circuit can be located on two different components of the mounting part, so that the pressure sensing chip and the signal processing circuit can be located on opposite sides of the mounting part, and the electrical connection between the pressure sensing chip and the signal processing circuit can be realized through the third lead post.

Referring to FIG. 11c, FIG. 11c illustrates a schematic diagram of a packaging structure of a mounting part and a pressure sensing chip. As shown in FIG. 11c, the mounting part can include a signal adapter plate and an insulating base arranged opposite to each other;

an insulating base 2013, a thick film circuit and a signal adapter plate 2012.

The signal adapter plate is located in the closed cavity, and the signal processing circuit is located on a side of the signal adapter plate away from the supporting part.

The thick film circuit is also arranged on the signal adapter plate, and the thick film circuit is arranged on the same side as the signal processing circuit and is electrically connected to the signal processing circuit.

The pressure sensing chip is arranged on a side of the insulating base away from the signal adapter plate.

The first signal output structure is packaged on a side of the insulating base away from the signal adapter plate, and an end of the third lead post is electrically connected to the first signal output structure, and the other end of the third lead post is electrically connected to the signal processing circuit after penetrating through the insulating base and the signal adapter plate in turn.

In this example, the packaging method between the pressure sensing chip and the packaging structure can be described with reference to the structure shown in FIG. 8b. The difference from the structure shown in FIG. 8b is in that the mounting part in this example includes the insulating base and the signal adapter plate. The insulating base can be connected to a sealed housing and a supporting part, and a closed cavity is formed between the insulating base and the sealed housing, the signal adapter plate is located in the closed cavity, and the insulating base can be located outside the closed cavity. The signal processing circuit is located on one side of the signal adapter plate, the first signal output structure of the pressure sensing chip is packaged on the insulating base, and the insulating base and the signal adapter plate can be connected through a third lead post penetrating through the insulating base and the signal adapter plate. On the one hand, the third lead post is used to input electrical signals output by the first signal output structure into the signal processing circuit; on the other hand, the third lead post plays a role in connecting the insulating base and the signal adapter plate and supporting the signal adapter plate.

The insulating base is made of insulating materials such as ceramics, glass, and the like Of course, as mentioned above, when connecting to the sealed housing made of metal materials, both ends of the insulating base can have metal connectors to be hermetically connected to the sealed housing through the metal connectors. A thick film circuit is arranged on the signal adapter plate, and the thick film circuit can be a PCB circuit board. The signal processing circuit is arranged on one side of the thick film circuit away from the signal adapter plate and is electrically connected to the thick film circuit.

Using the structure of the pressure sensor, since the mounting part includes the signal adapter plate and the insulating base, the pressure sensing chip and the signal processing circuit can be separately mounted on independent components. Therefore, compared with the structure shown in FIG. 11b, the insulating base and the pressure sensing chip or the signal adapter plate and the signal processing circuit can be simultaneously prepared in parallel processes, thereby improving the production efficiency.

In an implementation of this example, the supporting part is provided with a second through hole 223 allowing the media to be measured to flow in. One end of the second through hole is used for the media to be measured to flow in, and the other end of the second through hole exposes part or all of the region of the insulating base away from the signal adapter plate. As shown in FIG. 11c, there may be two supporting parts, and the second through hole is formed between the two supporting parts, so that the second through hole can completely expose the pressure sensing chip.

Specifically, as shown in FIG. 11d and FIG. 11e, FIG. 11d and FIG. 11e respectively illustrate schematic diagrams of packaging structures of two pressure sensors. As shown in FIG. 11d, the supporting part is provided with a second through hole, and the insulating base can be located at a liquid outlet of the second through hole. As shown in FIG. 11e, the insulating base can be located at a liquid inlet of the second through hole, where the liquid inlet is a position where external media to be measured flows into the supporting part, and the liquid outlet is an end position of the second through hole in the supporting part.

As shown in FIG. 11d, the insulating base and the pressure sensing chip are located at an end of the second through hole away from the external environment, that is, at the liquid outlet of the second through hole. The second through hole includes a first region and a second region connected to the first region. A radial size of the first region is greater than a radial size of the second region, so that the first region can be called a mounting table for connecting the insulating base and the pressure sensing chip, in this way, the insulating base and the pressure sensing chip are located in the first region. The arrangement of the second through hole of the supporting part shown in this example can be referred to FIG. 11b. The difference from FIG. 11b is in that the mounting part includes a signal adapter plate and an insulating base. The insulating base is connected to the supporting part and the sealed housing, so that a closed cavity is formed between an insulating part and the sealed housing. The signal adapter plate is located in the closed cavity, and two third lead posts penetrate through the insulating base. By using this assembly method, the pressure sensing chip is located on the top of the supporting part close to the insulating base, and the media to be measured need to be transmitted to the pressure sensing chip through the second through hole penetrating the supporting part. The packaging method has high reliability.

As shown in FIG. 11e, the insulating base and the pressure sensing chip are located on an end of the second through hole close to the external environment, that is, the insulating base can be located at a liquid inlet of the second through hole and hermetically connected to the second through hole of the supporting part, so that the pressure sensing chip is located at the liquid inlet. The two third lead posts penetrate through the insulating base and extend in the second through hole, and then penetrate through the signal adapter plate.

The difference from the packaging structure shown in FIG. 11d is in that the insulating base of FIG. 11d is hermetically connected to a top of the supporting part close to the closed cavity. In this example, the insulating base is hermetically connected to a bottom of the supporting part away from the closed cavity and is located in the second through hole opened in the supporting part. Specifically, the insulating base can be arranged at the liquid inlet of the second through hole and hermetically connected to flow channel walls of the second through hole. The closed cavity is composed of the insulating base, the supporting part and a sealed housing. A section of the insulating base where the second through hole is located away from the pressure sensing chip serves as a part of the closed cavity.

In this example, a vertical distance from a side of the insulating base away from the closed cavity to an entrance of the supporting part can be greater than or equal to a total thickness of the pressure sensing chip. In the case where the vertical distance is greater than the total thickness, a difference between the vertical distance and the total thickness of the pressure sensing chip can be less than 1 mm. A radial size of the second through hole can be greater than a size of the pressure sensing chip in a plane direction of the pressure-sensitive film, so as to mount the pressure sensing chip.

Using the packaging structure in this example, since the pressure sensing chip can be located at the liquid inlet of the second through hole, that is, at the end close to the external environment, it can be avoided that the pressure sensing chip is in a cavity environment, thereby avoiding the cavity effect on the performance testing of the pressure sensing chip, removing the high-frequency limitation on the pressure sensing chip caused by the cavity effect, and improving the use frequency of the pressure sensing chip.

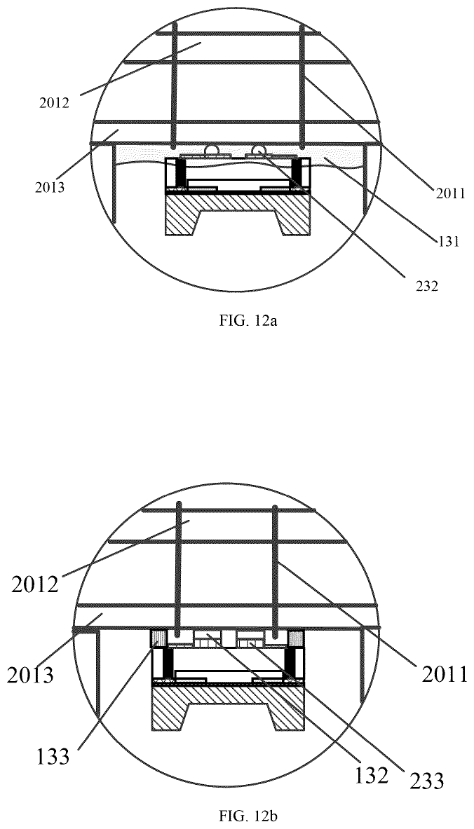

In the structure of the pressure sensor obtained by using the packaging method of the option C2, the pressure sensing chip and the signal processing circuit are located on the opposite sides of the mounting part (the pressure sensing chip is located outside the closed cavity). In a further example, two methods are provided to connect the first signal output structure of the pressure sensing chip to the mounting part. One way is shown in FIG. 12a, FIG. 12a is a schematic enlarged partial diagram of FIG. 11c. The first signal output structure can be welded to one side of the mounting part through solder joints arranged on the pressure sensing chip. In this case, since the pressure-sensitive film is exposed to the external environment, and the first signal output structure is not located in the closed cavity, the first signal output structure may also be corroded due to exposure to the external environment, which may affect the electrical performance. Therefore, the mounting part also includes a protective layer arranged on the same side as the pressure sensing chip. The protective layer completely covers the solder joints and has a thickness less than a thickness of the pressure sensing chip.

As shown in FIG. 12a, the first signal output structure can include spherical solder joints 523. During packaging, the pressure sensing chip can be packaged on one side of the mounting part away from the closed cavity through the spherical solder joints, and glass slurry is coated on the side of the mounting part away from the closed cavity by coating to form a protective layer. A thickness of the protective layer is greater than a thickness of the spherical solder joint and less than the thickness of the pressure sensing chip, so as to completely cover the spherical solder joints and a lower end face of the third lead post of the mounting part. Therefore, the protective layer can physically isolate the spherical solder joints from the media to be measured, thereby realizing the protection of the spherical solder joints and the first signal output structure, and allowing the media to be measured to directly contact the target region to realize pressure detection.

In another method, as shown in FIG. 12b, FIG. 12b illustrates another bonding method of FIG. 12a. The first signal output structure can be connected to one side of the mounting part by metal bonding. The first signal output structure of the pressure sensing chip can include two first bonding bumps. When the first signal output structure is connected to one side of the mounting part, the pressure sensing chip can be bonded to the mounting part through the two first bonding bumps arranged on the pressure sensing chip.

Accordingly, in this example, the mounting part further includes two slurry bonding layers arranged on the same side as the pressure sensing chip, and two second bonding bumps spaced apart from each other. The third lead posts are located outside the two first bonding bumps, and the slurry bonding layers are located outside the third lead posts.

The second bonding bumps are bonded to the first bonding bumps on the pressure sensing chip, and the slurry bonding layers are hermetically bonded to one side of the substrate of the pressure sensing chip away from the cavity.

Compared with the packaging structure of FIG. 12a, in this example, the second bonding bumps and the slurry bonding layers are added on the side of the mounting part away from the closed cavity. The material of the second bonding bumps can be the same as the material of the first bonding bumps, so as to facilitate the bonding between the second bonding bumps with the first bonding bumps. The slurry bonding layers can be located on outer sides of the third lead posts. The slurry bonding layers can be made of glass materials and can be formed by using a glass slurry screen printing process. The slurry bonding layers are hermetically bonded to one side of the substrate of the pressure sensing chip away from the cavity to protect the first bonding bumps and the second bonding bumps located between the slurry bonding layers, so that the first signal output structure of the pressure sensing chip is located in a sealed environment, thereby protecting the pressure sensing chip from the external environment.

By using this packaging method, the pressure sensing chip is connected to the mounting part by metal bonding, and thus the electrical interconnection between the pressure sensing chip and the mounting part can be realized. By using the slurry bonding layer, the pressure sensing chip is bonded to the first signal output structure, and thus the size and dosage of the protective layer for the pressure sensing chip can be effectively controlled, thereby reducing the process difficulty, and improving the yield.

Hereinafter, the structure of the pressure sensor is introduced through several examples to illustrate various packaging methods of the pressure sensing chip.

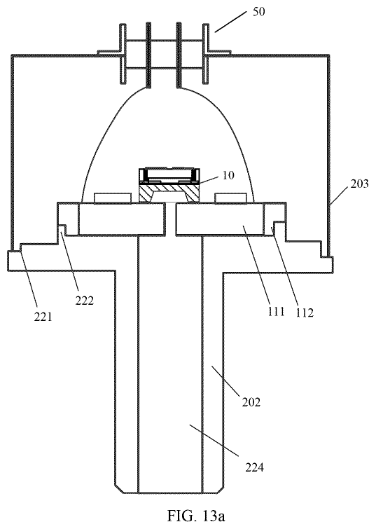

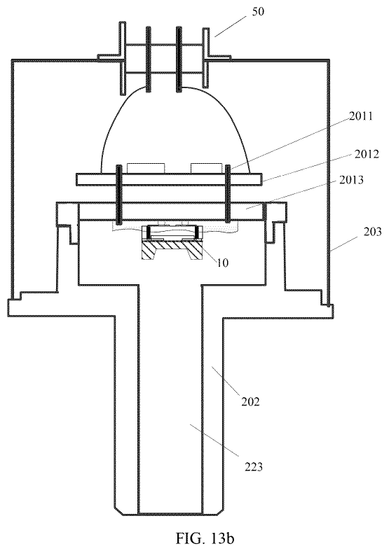

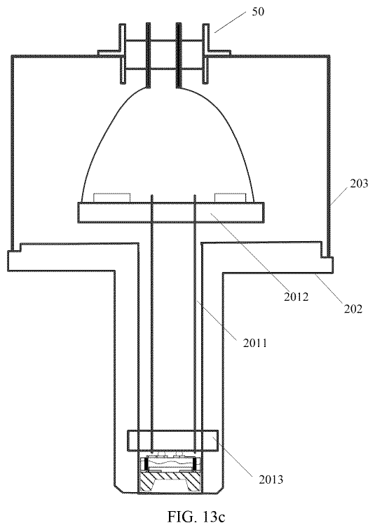

Example B1, referring to FIG. 13a, FIG. 13a illustrates a schematic cross-sectional structure of a pressure sensor. As shown in FIG. 13a, the pressure sensor in Example B1 is a piezoresistive pressure sensing chip. The packaging part in the packaging structure includes a supporting part, a mounting part and a sealed housing.

The mounting part can include an insulating part 111 and a metal part 112 connected to both ends of the insulating part. The insulating part can be ceramic, a signal processing circuit and a pressure sensing chip are respectively arranged on the same side of the mounting part, so that the pressure sensing chip can be located in the closed cavity. One side of the pressure-sensitive film of the pressure sensing chip away from the cavity is connected to the insulating part, the first signal output structure of the pressure sensing chip is electrically connected to a thick film circuit on the insulating part through metal wires, and the thick film circuit is electrically connected to the metal wires and the signal processing circuit respectively. The thick film circuit is a printed circuit board structure, and the signal processing circuit includes an ASIC chip and a resistance-capacitance component.

The supporting part is a T-shaped supporting part, and a supporting surface of the T-shaped supporting part includes a first mounting table and a second mounting table. The T-shaped supporting part further includes a first through hole 224 penetrating on a symmetry axis. The first mounting table is located outside the second mounting table, and two bosses 221 of the first mounting table are welded to the sealed housing. The second mounting table can include two bosses 222 oppositely arranged on the supporting surface, and the two bosses 222 are welded to the metal part in the mounting part.

The second signal output structure includes a connector, an insulator and a second lead post. The connector is hermetically connected to the sealed housing, both ends of the insulator are respectively connected to the connector, the second lead post penetrates through the insulator, and one end of the second lead post close to the closed cavity is electrically connected to the signal processing circuit through a second metal lead.

Metal parts in the connector, the sealed housing, the supporting part and the mounting part are all made of metal materials, and the materials can be the same, for example, the materials are copper, so as to reduce the welding difficulty.

The insulating part 111 of the mounting part includes a first through hole, which is connected to a first through hole on the supporting part. A diameter of the first through hole on the insulating part is less than a diameter of the first through hole on the supporting part, and an orthographic projection of the first through hole on the insulating part on the mounting part is covered by the orthographic projection of the cavity on the mounting part.

The media to be measured directly contact with one side of the pressure-sensitive film of the pressure sensing chip through the first through hole in the supporting part and the first through hole in the insulating part to apply the pressure to the cavity, so that the cavity deforms, and generated electrical signals are output through the first signal output structure. The electrical signals are input to a thick film circuit layer through metal wires, transmitted to the resistance-capacitance component and the ASIC chip in turn through the thick film circuit layer; after being amplified and filtered by the resistance-capacitance component and the ASIC chip, the electrical signals are transmitted to the second lead post through the AF wires, and then transmitted to an external measuring device.

Example B2, referring to FIG. 13b, FIG. 13b illustrates a schematic cross-sectional structure of a pressure sensor. As shown in FIG. 13b, the pressure sensor in Example B2 is a piezoresistive pressure sensing chip. The packaging part in the packaging structure includes a T-shaped supporting part, a mounting part and a sealed housing.

The mounting part can include an insulating base and a signal adapter plate. The insulating base includes an insulating part 111 and a metal part 112 connected to the insulating part. The insulating part can be ceramic, the metal part is welded to two bosses of the second mounting table of the T-shaped supporting part, so that the insulating base is hermetically connected to the T-shaped supporting part. The two bosses of the first mounting table are welded to the sealed housing, so that the sealed housing, the T-shaped supporting part and the insulating base are enclosed to form a closed cavity. The signal adapter plate is located in the closed cavity, the signal adapter plate can be arranged opposite to the insulating base, and the signal adapter plate and the insulating base can be parallel. A signal processing circuit is formed on one side of the signal adapter plate away from the insulating base. The signal processing circuit is the same as that in the above Example B1, and the second signal output structure is the same as that in the above Example B1.

The pressure sensing chip is located outside the closed cavity, and the first signal output structure of the pressure sensing chip is welded to one side of the insulating base 2013 away from the signal adapter plate through spherical solder joints. The insulating base penetrates through the third lead post 2011, and the third lead post also penetrates through the signal adapter plate 2012 and is electrically connected to the thick film circuit on the signal adapter plate. The side of the insulating base 2013 away from the signal adapter 2012 is coated with a circuit layer, which is used to realize the electrical connection between the third lead post and the first signal output structure.

A protective layer 131 is coated on one side of the insulating base away from the signal adapter plate. The protective layer can cover a welding region between the first signal output structure and the insulating base, thereby protecting the circuit of the first signal output structure from the external environment. The protective layer is coated with glass slurry, and a thickness of the protective layer needs to be less than the thickness of the pressure sensing chip to expose the pressure-sensitive film.

The second through hole 223 on the T-shaped supporting part includes a first region and a second region, and a size of the first region in a radial direction is greater than a size of the second region in the radial direction. The pressure sensing chip is located in the first region, and there is a gap between the pressure sensing chip and a second through hole wall in the first region.

The media to be measured directly contact one side of the pressure-sensitive film of the pressure sensing chip through the second through hole 223 on the supporting part to apply the pressure to the cavity, so that the cavity deforms and generated electrical signals are output through the first signal output structure. The electrical signals are transmitted from the welding region to the third lead post, then transmitted to the thick film circuit layer on the signal adapter plate through the third lead post, and transmitted to the resistance-capacitance component and the ASIC chip in turn through the thick film circuit layer; after being amplified and filtered by the resistance-capacitance component and the ASIC chip, the electrical signals are transmitted to the second lead post through the AF wires, and then transmitted to an external measuring device.

Example B3, referring to FIG. 13c, FIG. 13c illustrates a schematic cross-sectional structure of a pressure sensor. As shown in FIG. 13c, the packaging part of the pressure sensor in this Example B3 includes a supporting part, a mounting part and a sealed housing.

The mounting part can include an insulating base and a signal adapter plate. The insulating base includes an insulating part and a metal part connected to the insulating part, and the insulating part can be ceramic.

The T-shaped supporting part has a second through hole penetrating on a symmetry axis. The insulating base is located at an entrance of the second through hole, that is, on one side close to a bottom of the T-shaped supporting part. The insulating base is welded to a side wall of the second through hole through a metal part.

The two bosses of the first mounting table of the T-shaped supporting part are welded to the sealed housing, so that the sealed housing, the T-shaped supporting part and the insulating base are enclosed to form a closed cavity. The signal adapter plate is located in the closed cavity, the signal adapter plate can be arranged opposite to the insulating base, and the signal adapter plate and the insulating base can be parallel. A size of the insulating base can be less than a size of the signal adapter plate, and a signal processing circuit is formed on one side of the signal adapter plate away from the insulating base. The signal processing circuit is the same as that in the above Example B1, and the second signal output structure is the same as that in the above Example B1.

The first signal output structure of the pressure sensing chip is welded to one side of the insulating base away from the signal adapter plate through spherical solder joints. The insulating base penetrates through a third lead post. The third lead post also penetrates through the signal adapter plate and is electrically connected to a thick film circuit on the signal adapter plate. The side of the insulating base away from the signal adapter is coated with a circuit layer, which is used to realize the electrical connection between the third lead post and the first signal output structure.

A protective layer is coated on one side of the insulating base away from the signal adapter plate, and the arrangement of the protective layer is the same as that of the above Example B2. The pressure sensing chip is located at an entrance of the second through hole and can be flush with the T-shaped supporting part, so as to avoid the cavity effect.

Example B4, the difference from the above Example B3 is in that the first signal output structure of the pressure sensing chip is bonded to the second bonding bumps 132 of the insulating base through the first bonding bumps, and the side of the insulating base away from the signal adapter plate is provided with slurry bonding layers. The specific structure of the slurry bonding layers is shown in FIG. 12b.

Example B5, the difference from the above Example B1 to Example B3 is in that the pressure sensing chip is a capacitive sensing chip.

Based on the same inventive concept, the present disclosure also provides a method for packaging a pressure sensor, which is used to package the pressure sensor in any of the above-mentioned exemplary embodiments. Specifically, the method can include the following steps.

Step S101, a pressure sensing chip is mounted on a packaging part in a packaging structure, where the packaging part is provided with a closed cavity, and at least a signal processing circuit exists in the closed cavity.

Step S102, a first signal output structure on the pressure sensing chip is electrically connected to the signal processing circuit in the packaging structure, where at least the signal processing circuit exists in the closed cavity.

The pressure sensing chip can be mounted on the packaging part in the packaging structure in the following methods: a pressure-sensitive film of the pressure sensing chip is hermetically connected to the packaging part, and then the electrical connection between the first signal output structure and the signal processing circuit can be that an end of a metal wire on the first signal output structure is welded to the packaging part.

Alternatively, the first signal output structure on a substrate of the pressure sensing chip can be connected to the packaging part by welding, and the electrical connection between the first signal output structure and the signal processing circuit can be realized at the same time of welding connection.

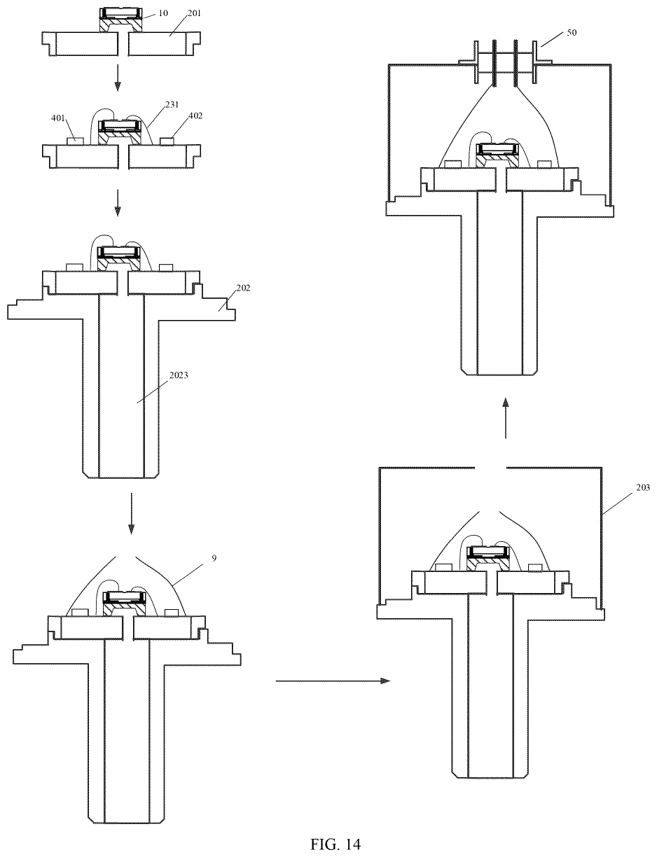

Taking the pressure sensor shown in the above Example B1 as an example to illustrate a packaging process. Referring to FIG. 14, FIG. 14 illustrates a schematic diagram of a packaging process. As shown in FIG. 14, the packaging process is as follows.

S1, bonding of a pressure sensing chip, as shown in FIG. 14. A mounting part is cleaned using organic solvents, and bonding glass slurry is prepared on an insulating part of the mounting part using screen printing. Note that the glass slurry should not block a first through hole structure of the insulating part. A pressure-sensitive film of the pressure sensing chip is placed on the glass slurry, and the pressure sensing chip is bonded to the insulating part after heating and curing. The bonding between the pressure sensing chip and the insulating part can also use bonding methods such as copper-copper, copper-tin and gold-tin besides glass slurry bonding.

S2, welding of an ASIC chip and a resistance-capacitance component, as shown in FIG. 14. The ASIC chip and the resistance-capacitance component are soldered on the insulating part using reflow soldering. After the welding is completed, metal leads are respectively bonded to the pressure sensing chip and the insulating part, and the ASIC chip and the insulating part using ultrasonic hot pressing bonding, so as to transmit electrical signals on the pressure sensing chip and the ASIC to the insulating part.

S3, welding of the mounting part, as shown in FIG. 14. A metal part of the mounting part is welded to a second mounting table of a T-shaped supporting part using laser welding or electron beam welding. In order to ensure the welding quality, the metal material of the metal part is preferably the same as the metal material of the T-shaped supporting part.

S4, welding of AF wires, as shown in FIG. 14. The AF wires are soldered to a thick film circuit of the insulating part using brazing, so as to transmit the electrical signals on the signal processing circuit to the AF wires.

S5, welding of a sealed housing, as shown in FIG. 14. The sealed housing is welded to the first mounting table of the T-shaped supporting part using laser welding or electron beam welding. In order to ensure the welding quality, the material of the sealed housing is preferably the same as the material of the T-shaped supporting part.

S6, welding of a second signal output structure, as shown in FIG. 14. Brazing is used. The AF wires are soldered to second lead posts using brazing, so as to transmit the electrical signals on the signal processing circuit to the second lead posts. The sealed housing and the connector are welded together using laser welding or electron beam welding to fix, and the sealed housing and the connector can also be fixed using gluing or screwing.

By using this packaging method, the packaging of the pressure sensing chip can be simplified, thereby reducing the packaging cost.

The first signal output structure on the substrate of the pressure sensing chip can be connected to the packaging part using welding, and the first signal output structure can be electrically connected to the signal processing circuit at the same time of welding connection. Hereinafter, two packaging processes for packaging the first signal output structure and the packaging part are provided.

In an example, the packaging part includes a mounting part, a supporting part and a sealed housing. The mounting part is connected to the supporting part, and the sealed housing, the mounting part and the supporting part enclose to form a closed cavity. Then, solder joints in a first signal output structure can be welded on solder joints of the mounting part, so that the first signal output structure and the signal processing circuit are located on opposite sides of the mounting part, respectively. Accordingly, the signal processing circuit can be formed at one side of the mounting part, and the solder joints in the first signal output structure are welded to the side of the mounting part away from the signal processing circuit, so that the first signal output structure is electrically connected to the signal processing circuit. Then, a protective layer is formed on the side of the mounting part away from the signal processing circuit. The protective layer covers a welding region between the first signal output structure and the mounting part, and a thickness of the protective layer is less than a thickness of the pressure sensing chip.

In this example, the packaging part can include a supporting part, a mounting part and a sealed housing, and the pressure sensing chip is packaged with the mounting part. The structures of the supporting part, the mounting part and the sealed housing can be shown with reference to the structures of the above Example B1 to Example B3.

The structures of the above Example B2 and Example B3 can be obtained using the packaging method in this example.

Specifically, the packaging process can be combined with the process described in FIG. 14. The difference from FIG. 14 is in that the welding of the mounting part and the welding of the pressure sensing chip. In this example, the process of welding the pressure sensing chip can be as follows.

An insulating base in the mounting part is cleaned using organic solvents, and a laser is aligned with the solder joints, so that the solder joints are welded to a surface of the insulating base. At the same time, glass slurry is coated on the insulating base, and a protective layer is formed to protect the welding region after curing. When coating, it is noted that a thickness of the glass slurry cannot exceed a lower surface of the pressure-sensitive film.

The welding process of the mounting part can be as follows.

First, the metal part of the insulating base is welded to the second mounting table of the T-shaped supporting part using laser welding or electron beam welding. In order to ensure the welding quality, the metal material of the metal part is preferably the same as the material of the T-shaped supporting part. Due to the support of third lead posts, a signal adapter plate is fixed synchronously after the insulating base is welded.

The packaging method between the signal adapter plate and the signal processing circuit can refer to the above step S2.

In yet another example, the packaging part includes a mounting part, a supporting part and a sealed housing. The mounting part is connected to the supporting part, and the sealed housing, the mounting part and the supporting part enclose to form a closed cavity. Slurry bonding layers and second bonding bumps spaced apart are formed on the mounting part, and the slurry bonding layers are located outside the two first bonding bumps.

The first bonding bumps and the second bonding bumps on the pressure sensing chip can be bonded, so that the first signal output structure and the signal processing circuit are located on the opposite sides of the mounting part, respectively. Specifically, the signal processing circuit can be formed on the side of the mounting part away from the second bonding bumps; the first bonding bumps on the pressure sensing chip are bonded to the second bonding bumps, so that the first signal output structure is electrically connected to the signal processing circuit; and one side of the substrate on the pressure sensing chip is bonded to the slurry bonding layer.

In this example, the packaging part can include a supporting part, a mounting part and a sealed housing, and the pressure sensing chip is packaged with the mounting part. The structures of the supporting part, the mounting part and the sealed housing can be shown with reference to the structures of the above Example B2 and Example B3, and the pressure sensor of the above Example B4 can be obtained using the packaging method in this example.

Specifically, the packaging process can be combined with the process described in FIG. 14. The difference from FIG. 14 is in that the welding of the mounting part and the welding of the pressure sensing chip. In this example, the process of welding the pressure sensing chip can be as follows.

An insulating base in the mounting part is cleaned using organic solvents, the second bonding bumps on the insulating base are aligned with the first bonding bumps on the pressure sensing chip, and the slurry bonding layers on the insulating base are aligned with the substrate, and then bonding is started. After bonding, the first signal output structure is hermetically protected by the slurry bonding layers, and thus compared with the welding method in the above example, the process difficulty can be reduced.

The welding process of the mounting part can be as follows.

First, the metal part of the insulating base is welded to the second mounting table of the T-shaped supporting part using laser welding or electron beam welding. In order to ensure the welding quality, the metal material of the metal part is preferably the same as the material of the T-shaped supporting part. Due to the support of third lead posts, a signal adapter plate is fixed synchronously after the insulating base is welded.

Alternatively, the metal part of the insulating base is welded at a position where the first through hole of the T-shaped supporting part is close to an entrance using laser welding or electron beam welding. In order to ensure the welding quality, the metal material of the metal part is preferably the same as the material of the T-shaped supporting part. Due to the support of third lead posts, a signal adapter plate is fixed synchronously after the insulating base is welded.

The packaging method between the signal adapter plate and the signal processing circuit can refer to the above step S2.

Each embodiment in the present specification is described in a progressive manner, each embodiment highlights the difference from other embodiments, and the same or similar parts between the embodiments can be referred to each other.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

The above provides a detailed introduction to the pressure sensing chip and the pressure sensor provided by the present disclosure. The principle and the embodiments of the present disclosure are described herein with reference to the particular examples, and the description of the above embodiments is merely intended to facilitate to understand the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

After considering the specification and practicing the inventions disclosed here, a person skilled in the art will easily think of other embodiments of the present disclosure. The present disclosure aims to cover any variations, uses or adaptive changes in present disclosure. These variations, uses or adaptive changes follow the general principles of the present disclosure and include public knowledge or common technical means in this art that are not disclosed in the present disclosure. Specification and embodiments are only treated as illustrative, and the true scope and spirit of this disclosure are stated in the following claims.

It should be understood that the present disclosure is not limited to the accurate structure that has been described above and shown in the drawings, and may have various modifications and variations without departing from its scope. The scope of the present disclosure is merely limited by the appended claims.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The description provided herein describes many concrete details. However, it may be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he may still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A pressure sensing chip, comprising:
a pressure-sensitive film;
a substrate connected to the pressure-sensitive film, wherein a cavity is formed between the pressure-sensitive film and the substrate;
a pressure-sensitive component located between the substrate and the pressure-sensitive film, wherein the pressure-sensitive component partially overlaps with an orthographic projection of the cavity on the substrate; and
a first signal output structure arranged on a side of the substrate away from the pressure-sensitive film,
wherein the first signal output structure is electrically connected to the pressure-sensitive component through a lead structure penetrating through the substrate.

2. The pressure sensing chip according to claim 1, wherein an orthographic projection of the pressure-sensitive component on the substrate is located within the orthographic projection of the cavity on the substrate.

3. The pressure sensing chip according to claim 1, wherein the pressure-sensitive component is located on a side of the pressure-sensitive film close to the substrate, or the pressure-sensitive component is distributed on opposite sides of the cavity in a target direction, wherein the target direction is a vertical direction that the substrate towards the pressure-sensitive film.

4. The pressure sensing chip according to claim 3, wherein the pressure-sensitive component comprises a first electrode and a second electrode arranged at intervals, and the first electrode and the second electrode are both arranged on a side of the pressure-sensitive film close to the cavity,
wherein the first electrode and the second electrode are configured to convert a deformation of the pressure-sensitive film into a resistance signal; or
wherein the pressure-sensitive component comprises a third electrode and a fourth electrode, and the third electrode and the fourth electrode are configured to convert a deformation of the pressure-sensitive film into a capacitance signal,
wherein the third electrode is arranged on the side of the pressure-sensitive film close to the cavity, the fourth electrode is arranged on a side of the substrate close to the cavity, and an orthographic projection of the third electrode on the substrate overlaps with the fourth electrode.

5. (canceled)

6. The pressure sensing chip according to claim 1, wherein the pressure-sensitive film comprises a thinned region and a non-thinned region, and a thickness of the thinned region is less than a thickness of the non-thinned region,
wherein an orthographic projection of the thinned region on the substrate overlaps with the orthographic projection of the cavity on the substrate,
wherein an insulating layer is further arranged on a side of the pressure-sensitive film close to the substrate, wherein the pressure-sensitive component is located on a side of the insulating layer away from the pressure-sensitive film.

7. The pressure sensing chip according to claim 6, wherein the orthographic projection of the thinned region on the substrate is covered by the orthographic projection of the cavity on the substrate, and an orthographic projection of the non-thinned region on the substrate overlaps with the orthographic projection of the cavity on the substrate.

8. The pressure sensing chip according to any one of claims 1, wherein the lead structure comprises a first lead post and an extraction electrode, one end of the extraction electrode is connected to the pressure-sensitive component, the other end of the extraction electrode is connected to one end of the first lead post, and the other end of the first lead post penetrates through the substrate and is electrically connected to the first signal output structure,
wherein an orthographic projection of the extraction electrode on the substrate does not overlap with the orthographic projection of the cavity on the substrate.

9. The pressure sensing chip according to claim 8, wherein the extraction electrode is arranged in a same layer as the pressure-sensitive component.

10-11. (canceled)

12. The pressure sensing chip according to claim 1, wherein the pressure sensing chip further comprises: a spacer and a sealing ring located on at least one side of the spacer,
wherein the pressure-sensitive film is hermetically connected to the substrate through the sealing ring and the spacer.

13. The pressure sensing chip according to claim 1, wherein the first signal output structure comprises a signal access terminal and a signal output terminal, wherein the signal access terminal is respectively connected to the first lead post and the signal output terminal, and the signal output terminal is configured to transmit electrical signals input by the signal access terminal to an external signal processing circuit.

14. The pressure sensing chip according to claim 13, wherein the signal access terminal comprises:
a metal binding region arranged on a side of the substrate away from the cavity and electrically connected to the first lead post; and
a metal transition region arranged on the side of the substrate away from the pressure-sensitive film and respectively connected to the metal binding region and the signal output terminal.

15. The pressure sensing chip according to claim 14, wherein the signal output terminal comprises any one of a metal wire, a solder joint and a first bonding bump, wherein the first bonding bump and the metal transition region are integrally formed for bonding with a second bonding bump on the external signal processing circuit.

16. A pressure sensor, comprising the pressure sensing chip according to claim 1 and a packaging structure, wherein the packaging structure comprises:
a signal processing circuit;
a packaging part, wherein the pressure sensing chip is mounted on the packaging part, the packaging part is provided with a closed cavity, and at least the signal processing circuit exists in the closed cavity; and
a second signal output structure configured to the packaging part,
wherein the first signal output structure of the pressure sensing chip is electrically connected to an input terminal of the signal processing circuit, an output terminal of the signal processing circuit is electrically connected to the second signal output structure, and the second signal output structure is configured to outwardly output electrical signals processed by the signal processing circuit.

17. The pressure sensor according to claim 16, wherein the pressure sensing chip as a whole is located outside the closed cavity, and the first signal output structure is connected to the packaging part; or
the pressure sensing chip as a whole is located in the closed cavity, wherein the pressure-sensitive film is hermetically connected to the packaging part, the packaging part is provided with a through hole allowing media to be measured to flow in, and the through hole is connected to the pressure-sensitive film.

18. The pressure sensor according to claim 16, wherein the packaging part comprises:
a mounting part, wherein the pressure sensing chip and the signal processing circuit are mounted on a same side or opposite sides of the mounting part;
a supporting part connected to the mounting part for supporting the mounting part; and
a sealed housing is hermetically connected to the supporting part to form the closed cavity with the supporting part; or the sealed housing is hermetically connected to the mounting part to form the closed cavity with the supporting part,
wherein the second signal output structure is connected to the sealed housing.

19. The pressure sensor according to claim 18, wherein the pressure sensing chip and the signal processing circuit are located on a same side of the mounting part, and the pressure-sensitive film of the pressure sensing chip is bonded to the mounting part,
wherein the mounting part and the supporting part are each provided with a first through hole allowing media to be measured to flow in, and a side of the pressure-sensitive film away from the cavity is connected to the first through hole,
wherein a radius of the first through hole in the mounting part is less than a radius of the first through hole in the supporting part.

20. (canceled)

21. The pressure sensor according to claim 18, wherein the pressure sensing chip and the signal processing circuit are located on opposite sides of the mounting part, there is a gap between the pressure sensing chip and the supporting part, and the first signal output structure is bonded to the mounting part; and
a third lead post penetrates through the mounting part, one end of the third lead post is connected to the first signal output structure, and the other end is connected to the signal processing circuit.

22. The pressure sensor according to claim 21, wherein the mounting part comprises: a signal adapter plate and an insulating base arranged opposite to each other, wherein the signal adapter plate is located in the closed cavity, and the signal processing circuit is located on a side of the signal adapter plate away from the supporting part;
wherein the signal adapter plate is further provided with a thick film circuit, the thick film circuit is arranged on a same side as the signal processing circuit and is electrically connected to the signal processing circuit; and
wherein the first signal output structure is packaged on a side of the insulating base away from the signal adapter plate, an end of the third lead post is electrically connected to the first signal output structure, and the other end of the third lead post is electrically connected to the signal processing circuit after penetrating through the insulating base and the signal adapter plate in turn.

23. The pressure sensor according to claim 21, wherein the supporting part is provided with a second through hole penetrating therethrough, wherein one end of the second through hole is used to flow the media to be measured, and the other end of the second through hole is connected to a side of the pressure-sensitive film away from the cavity.

24. The pressure sensor according to claim 22, wherein the insulating base and the pressure sensing chip are located at a liquid outlet of the second through hole, and the second through hole is arranged on the supporting part; or
the insulating base and the pressure sensing chip are located at a liquid inlet of the second through hole, the insulating base is hermetically connected to the second through hole, and two third lead posts penetrate through the signal adapter plate after penetrating through the insulating base and extending in the second through hole.

25-26. (canceled)
